(19) United States
(12) Patent Application Publication
(10) Pub. No.: US 2017/0038829 A1
(43) Pub. Date: Feb. 9, 2017

(54) SOCIAL INTERACTION FOR REMOTE COMMUNICATION

(71) Applicant: Microsoft Technology Licensing, LLC, Redmond, WA (US)

(72) Inventors: Jaron Lanier, Berkeley, CA (US); Andrea Won, San Francisco, CA (US); Javier Arturo Porras Luraschi, Redmond, WA (US); Wayne Chang, Bellevue, WA (US)

(21) Appl. No.: 14/953,662

(22) Filed: Nov. 30, 2015

Related U.S. Application Data
(63) Continuation-in-part of application No. 14/821,505, filed on Aug. 7, 2015.

(51) Int. Cl. G06F 3/01; G06F 3/0488; H04L 29/06; G06F 3/03; G06F 3/14; G06T 13/40; G06T 19/00

(52) U.S. Cl. CPC G06F 3/011; G06T 13/40; G06F 3/04883; G06T 19/006; G06F 3/0304; G06F 3/1454; H04L 65/403; H04L 67/38

(57) ABSTRACT

Techniques for enabling two or more remotely located users to interact with one another and for causing virtual content that corresponds to individual users of the two or more users to augment virtual representations of the individual users in a remote communication environment is described. A service provider can receive image data and tracking data associated with a first user corresponding to a first device. Further, a service provider can cause a virtual representation of the first user to be presented on a display of a second device corresponding to a second user, determine an interaction between an object associated with the second user and the virtual representation of the first user, and based at least in part on determining the interaction, cause virtual content to be presented on the virtual representation of the first user on at least the display.

### RELATED APPLICATION

This application is a continuation-in-part, claiming the benefit of U.S. application Ser. No. 14/821,505, entitled “Mixed Reality Social Interactions,” filed on Aug. 7, 2015, the entire contents of which are incorporated herein by reference.

### BACKGROUND

Virtual reality is a technology that leverages computing devices to generate environments that simulate physical presence in physical, real-world scenes or imagined worlds (e.g., virtual scenes) via a display of a computing device. In virtual reality environments, social interaction is achieved between computer-generated graphical representations of a user or the user's character (e.g., an avatar) in a computer-generated environment. Mixed reality is a technology that merges real and virtual worlds. Mixed reality is a technology that produces mixed reality environments where a physical, real-world person and/or objects in physical, real-world scenes co-exist with a virtual, computer-generated person and/or objects in real time. For example, a mixed reality environment can augment a physical, real-world scene and/or a physical, real-world person with computer-generated graphics (e.g., a dog, a castle, etc.) in the physical, real-world scene.

Co-located and/or remotely located users can communicate via virtual reality or mixed reality technologies. Various additional and/or alternative technologies are available to enable remotely located users to communicate with one another. For instance, remotely located users can communicate via visual communication service providers that leverage online video chat, online voice calls, online video conferencing, remote desktop sharing, etc.

### SUMMARY

Techniques for enabling two or more remotely located users to interact with one another and for causing virtual content that corresponds to individual users of the two or more users to augment virtual representations of the individual users in a remote communication environment are described. A service provider can receive image data and tracking data associated with a first user corresponding to a first device. Further, a service provider can cause a virtual representation of the first user to be presented on a display of a second device corresponding to a second user, determine an interaction between an object associated with the second user and the virtual representation of the first user, and based at least in part on determining the interaction, cause virtual content to be presented on the virtual representation of the first user on at least the display.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a schematic diagram showing an example environment for enabling two or more users in a mixed reality environment and/or a remote communication environment to interact with one another and to cause virtual content that corresponds to individual users of the two or more users to augment the individual users in the mixed reality environment and/or the remote communication environment.

FIG. 2 is a schematic diagram showing an example of a head mounted mixed reality display device.

FIG. 3 is a schematic diagram showing an example of a third person view of two users interacting in a mixed reality environment.

FIG. 4 is a schematic diagram showing an example of a first person view of a user interacting with another user in a mixed reality environment.

FIG. 5 is a flow diagram that illustrates an example process to cause virtual content to be presented in a mixed reality environment via a mixed reality display device.

FIG. 6 is a flow diagram that illustrates an example process to cause virtual content to be presented in a mixed reality environment via a mixed reality display device.

FIG. 7A is a schematic diagram showing an example of a third person view of two users interacting in a remote communication environment.

FIG. 7B is a schematic diagram showing another example of a third person view of two users interacting in a remote communication environment.

FIG. 8A is a schematic diagram showing yet another example of a third person view of two users interacting in a remote communication environment.

FIG. 8B is a schematic diagram showing yet a further example of a third person view of two users interacting in a remote communication environment.

FIG. 9 is a flow diagram that illustrates an example process to cause virtual content to be presented in a remote communication environment via a display device.

FIG. 10 is a flow diagram that illustrates another example process to cause virtual content to be presented in a remote communication environment via a display device.

### DETAILED DESCRIPTION

This disclosure describes techniques for enabling two or more users to interact with one another in a remote communication environment and to cause virtual content that corresponds to individual users of the two or more users to augment virtual representations of the individual users in the remote communication environment. The techniques described herein can enhance communications between remotely located users in remote communication environments. The techniques described herein can have various applications, including but not limited to, enabling conversational partners to visualize one another in mixed reality environments and/or remote communication environments, share joint sensory experiences in same and/or remote mixed reality and/or remote communication environments, add, remove, modify, etc. markings to body representations associated with the users in mixed reality and/or remote communication environments, view biological signals associated with other users in the mixed reality and/or remote communication environments, etc. Additionally and/or alternatively, the techniques described herein can have applications in health care such as in therapeutically treating chronic pain and/or movement disorders, remote physical therapy appointments, etc. The techniques described herein generate enhanced user interfaces whereby virtual content is rendered in the user interfaces such to overlay a virtual representation (e.g., an image) of a user. The enhanced user interfaces presented on displays of devices improve social interactions between users and the mixed reality and/or remote communication experience.

For the purposes of this discussion, physical, real-world objects (“real objects”) or physical, real-world people (“real people” and/or “real person”) describe objects or people, respectively, that physically exist in a physical, real-world scene (“real scene”) associated with a mixed reality display and/or other display device. Real objects and/or real people can move in and out of a field of view based on movement patterns of the real objects and/or movement of a user and/or user device. Virtual, computer-generated content (“virtual content”) can describe content that is generated by one or more computing devices to supplement the real scene in a user's field of view. In at least one example, virtual content can include one or more pixels each having a respective color or brightness that are collectively presented on a display such to represent a person, object, etc. that is not physically present in a real scene. That is, in at least one example, virtual content can include two dimensional or three dimensional graphics that are representative of objects (“virtual objects”), people (“virtual people” and/or “virtual person”), biometric data, effects, etc. Virtual content can be rendered into the mixed reality environment and/or remote communication environment via techniques described herein. In additional and/or alternative examples, virtual content can include computer-generated content such as sound, digital photographs, videos, global positioning system (GPS) data, etc.

In at least one example, the techniques described herein include receiving data from a sensor. As described in more detail below, the data can include tracking data associated with the positions and orientations of the users and data associated with a real scene in which at least one of the users is physically present. Based at least in part on receiving the data, the techniques described herein can include determining that a first user that is physically present in a real scene and/or an object associated with the first user causes an interaction between the first user and/or object and a second user that is present in the real scene. Based at least in part on determining that the first user and/or object causes an interaction with the second user, the techniques described herein can include causing virtual content corresponding to the interaction and at least one of the first user or the second user to be presented on a user interface corresponding to a mixed reality device and/or other display device associated with the first user. The virtual content can be presented based on a viewing perspective of the respective users (e.g., a location of a mixed reality device and/or other display device within the real scene).

Virtual reality can completely transform the way a physical body of a user appears. In contrast, mixed reality alters the visual appearance of a physical body of a user. As described above, mixed reality experiences offer different opportunities to affect self-perception and new ways for communication to occur. Similar technologies can be applicable in remote communication environments. In at least one example, the techniques described herein enable users to interact with one another in mixed reality environments using mixed reality devices. In other examples, the techniques described herein enable users to interact with one another in remote communication environments using devices such as tablets, phones, etc. As non-limiting examples, the techniques described herein can enable conversational partners to visualize one another in mixed reality environments and/or remote communication environments, share joint sensory experiences in same and/or remote communication environments, add, remove, modify, etc. markings to body representations associated with the users in mixed reality environments and/or remote communication environments, view biological signals associated with other users in mixed reality environments and/or remote communication environments, etc. Additionally and/or alternatively, as described above, the techniques described herein can have applications in health care such as in therapeutically treating chronic pain and/or movement disorders, remote physical therapy appointments, etc.

For instance, the techniques described herein can enable conversational partners (e.g., two or more users) to visualize one another. In at least one example, based at least in part on conversational partners being physically located in a same real scene, conversational partners can view each other in mixed reality environments associated with the real scene. In alternative examples, conversational partners that are remotely located can view virtual representations (e.g., avatars) of each other in the individual real scenes that each of the partners is physically present in remote communication environments. That is, a first user can view a virtual representation (e.g., avatar) of a second user from a third person perspective in the real scene where the first user is physically present. In some examples, conversational partners can swap viewpoints. That is, a first user can access the view point of a second user such that the first user can be able to see a graphical representation of them from a third person perspective (i.e., the second user's point of view). In additional or alternative examples, conversational partners can view each other from a first person perspective as an overlay over their own first person perspective. That is, a first user can view a first person perspective of the second user and can view a first person perspective from the viewpoint of the second user as an overlay of what can be seen by the first user.

Additionally or alternatively, the techniques described herein can enable conversational partners to share joint sensory experiences in same and/or remote environments. In at least one example, a first user and a second user that are both physically present in a same real scene can interact with one another and affect changes to the appearance of the first user and/or the second user that can be perceived via mixed reality devices. In an alternative example, a first user and a second user who are not physically present in a same real scene (e.g., are remotely located) can interact with one another in a mixed reality environment and/or remote communication environment, for instance, via mixed reality devices or remote communication devices, respectively.

For the purpose of this discussion, a remote communication environment is an environment whereby two or more users, who are located in at least two distinct geographic locations, can communicate. In some examples, a remote communication environment can be a mixed reality environment. In other examples, a remote communication environment can be an environment created via a two-dimensional visual communications service provider. Examples of two-dimensional visual communications service providers include service providers for online video chat and/or online video call, online video conferencing, desktop sharing, etc. Examples of online video chat and/or online video call service providers include SKYPE®, FACETIME®, GOOGLE+ HANGOUTS®, etc. Examples of online video conferencing service providers include SKYPE®, GOOGLE+ HANGOUTS®, UBER CONFERENCE®, WEBEX®, etc. Examples of desktop sharing service providers include SKYPE®, GOOGLE+ HANGOUTS®, JOIN.ME®, etc.

In examples where a first user and a second user who are not physically present in a same real scene (e.g., are remotely located) interact with one another in a mixed reality environment and/or remote communication environment, streaming data (e.g., one or more frames of image data) can be sent to the mixed reality device and/or other display device associated with the first user to cause the second user to be virtually presented (e.g., via a virtual representation of the second user) via the mixed reality device and/or other display device associated with the first user. The first user and the second user can interact with each other via real and/or virtual objects and affect changes to the appearance of the first user or the second user that can be perceived via mixed reality devices and/or other display devices. In additional and/or alternative examples, a first user may be physically present in a real scene remotely located away from the second user and may interact with a device and/or a virtual object to affect changes to the appearance of the second user via mixed reality devices and/or other display devices. In such examples, the first user may be visually represented in the second user's mixed reality environment and/or remote communication environment or the first user may not be visually represented in the second user's mixed reality environment and/or remote communication environment.

As a non-limiting example, if a first user causes contact between the first user and a second user's hand (e.g., physically or virtually), the first user and/or second user can see the contact appear as a color change on the second user's hand via the mixed reality device and/or other display devices. For the purpose of this discussion, contact can refer to physical touch or virtual contact, as described below. In some examples, the color change can correspond to a position where the contact occurred on the first user and/or the second user. In additional or alternative examples, a first user can cause contact with the second user via a virtual object (e.g., a paintball gun, a ball, etc.). For instance, the first user can shoot a virtual paintball gun at the second user and cause a virtual paintball to contact the second user. Or, the first user can throw a virtual ball at the second user and cause contact with the second user. In such examples, if a first user causes contact with the second user, the first user and/or second user can see the contact appear as a color change on the second user via the mixed reality device and/or other display devices. As an additional non-limiting example, a first user can interact with the second user (e.g., physically or virtually) by applying a virtual sticker, virtual tattoo, virtual accessory (e.g., an article of clothing, a crown, a hat, a handbag, horns, a tail, etc.), etc. to the second user as he or she appears on a mixed reality device and/or other display devices. In some examples, the virtual sticker, virtual tattoo, virtual accessory, etc. can be privately shared between the first user and the second user for a predetermined period of time or infinitely linked to the first user and the second user (e.g., similar to a real tattoo).

In additional or alternative examples, virtual contact can be utilized in various health applications such as for calming or arousing signals, derivations of classic mirror therapy (e.g., for patients that have severe allodynia), etc. In another health application example, virtual contact can be utilized to provide guidance for physical therapy treatments of a remotely located physical therapy patient, for instance, by enabling a therapist to correct a patient's movements and/or identify positions on the patient's body where the patient should stretch, massage, ice, etc. Moreover, in additional and/or alternative health applications, virtual contact can be utilized to soothe perceived pain or anxiety. For instance, a first user can interact with a second user (e.g., physically or virtually) by applying a virtual Band-Aid® to a position on the second user or a virtual representation of the second user that corresponds to an injury (e.g., scraped knee, paper cut, etc.). Or, a first user can interact with a second user (e.g., physically or virtually) by caressing a body part on the second user or a virtual representation of the second user. As a result, the body part or the area of the body of the second user or the virtual representation of the second user that the first user caresses can turn a different color or be augmented with virtual content showing where the first user caressed the second user.

In some examples, as described above, a first user and a second user can be located in different real scenes (i.e., the first user and the second user are remotely located). A virtual object can be caused to be presented to both the first user and the second user via their respective mixed reality devices and/or other display devices. The virtual object can be manipulated by both users. Additionally, in some examples, the virtual object can be synced to trigger haptic feedback. For instance, as a non-limiting example, when a first user taps or strokes the virtual object, a second user can experience a haptic sensation associated with the virtual object via a mixed reality device and/or a peripheral device associated with the mixed reality device and/or other display devices. In alternative examples, linked real objects can be associated with both the first user and the second user. In some examples, the real object can be synced to provide haptic feedback. For instance, as a non-limiting example, when a first user taps or strokes the real object associated with the first user, a second user can experience a haptic sensation associated with the real object.

In additional or alternative examples, techniques described herein can enable conversational partners to view biological signals associated with other users in the mixed reality environments and/or remote communication environments. For instance, utilizing physiological sensors to determine physiological data associated with a first user, a second user can be able to observe physiological information associated with the first user. That is, virtual content (e.g., graphical representations, etc.) can be caused to be presented in association with the first user such that the second user can observe physiological information about the first user. As a non-limiting example, the second user can be able to see a graphical representation of the first user's heart rate, temperature, etc. In at least one example, a user's heart rate can be graphically represented by a pulsing aura associated with the first user and/or the user's skin temperature can be graphically represented by a color changing aura associated with the first user.

### Illustrative Environments

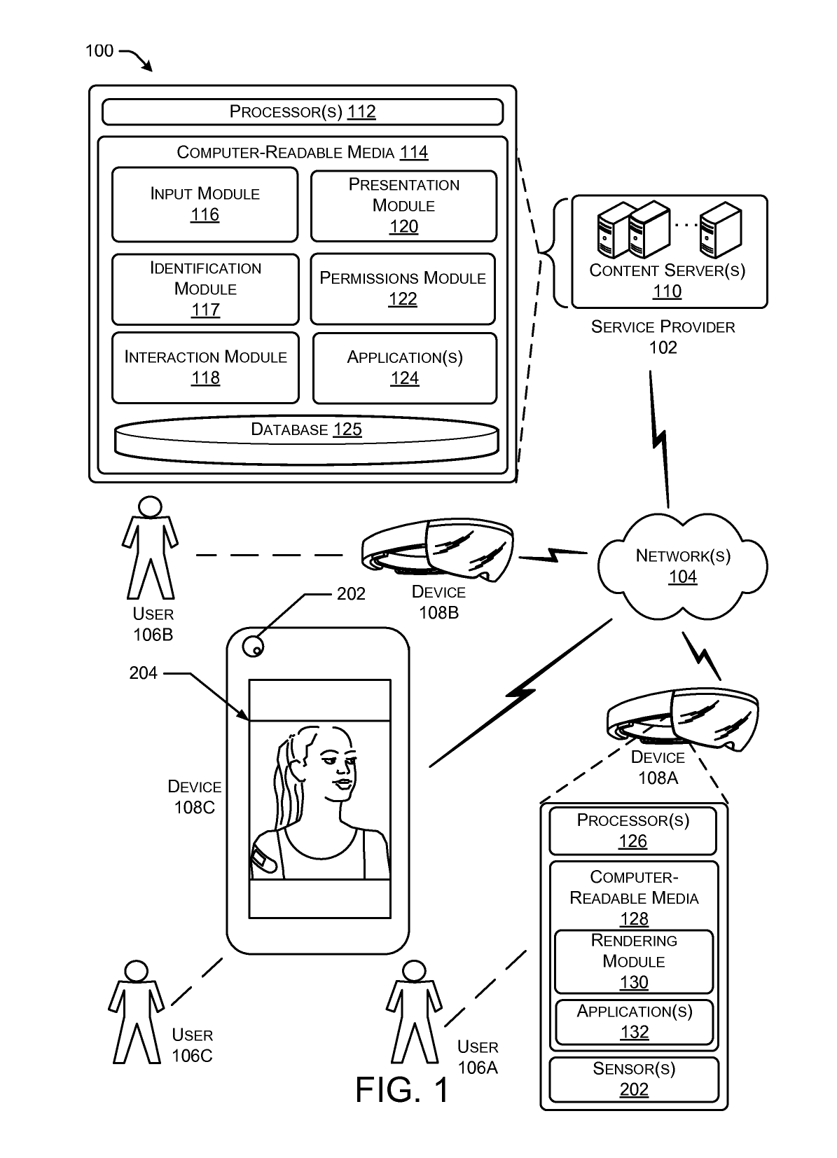

FIG. 1 is a schematic diagram showing an example environment 100 for enabling two or more users to interact with one another in a mixed reality environment and/or remote communication environment and for causing individual users of the two or more users to be presented in the mixed reality environment and/or remote communication environment with virtual content that corresponds to the individual users. More particularly, the example environment 100 can include a service provider 102, one or more networks 104, one or more users 106 (e.g., user 106A, user 106B, user 106C) and one or more devices 108 (e.g., device 108A, device 108B, device 108C) associated with the one or more users 106.

The service provider 102 can be any entity, server(s), service provider, console, computer, etc., that facilitates two or more users 106 interacting in a mixed reality environment and/or remote communication environment to enable individual users (e.g., user 106A, user 106B, user 106C) of the two or more users 106 to be presented in the mixed reality environment and/or remote communication environment with virtual content that corresponds to the individual users (e.g., user 106A, user 106B, user 106C). The service provider 102 can be implemented in a non-distributed computing environment or can be implemented in a distributed computing environment, possibly by running some modules on devices 108 or other remotely located devices. As shown, the service provider 102 can include one or more server(s) 110, which can include one or more processing unit(s) (e.g., processor(s) 112) and computer-readable media 114, such as memory. In various examples, the service provider 102 can receive data from a sensor. Based at least in part on receiving the data, the service provider 102 can determine that a first user (e.g., user 106A) that is physically present in a real scene and/or an object associated with the first user (e.g., user 106A) interacts with a second user (e.g., user 106B) that is present in the real scene. The second user (e.g., user 106B) can be physically or virtually present. Additionally, based at least in part on determining that the first user (e.g., user 106A) and/or the object associated with the first user (e.g., user 106A) interacts with the second user (e.g., user 106B), the service provider 102 can cause virtual content corresponding to the interaction and at least one of the first user (e.g., user 106A) or the second user (e.g., user 106B) to be presented on a first mixed reality device (e.g., device 108A) and/or other display device (e.g., device 108A) associated with the first user (e.g., user 106A) and/or a second mixed reality device (e.g., device 108B) and/or other display device (e.g., device 108B) associated with the second user (e.g., user 106B).

In some examples, the networks 104 can be any type of network known in the art, such as the Internet. Moreover, the devices 108 can communicatively couple to the networks 104 in any manner, such as by a global or local wired or wireless connection (e.g., local area network (LAN), intranet, Bluetooth, etc.). The networks 104 can facilitate communication between the server(s) 110 and the devices 108 associated with the one or more users 106.

Examples support scenarios where device(s) that can be included in the one or more server(s) 110 can include one or more computing devices that operate in a cluster or other clustered configuration to share resources, balance load, increase performance, provide fail-over support or redundancy, or for other purposes. Device(s) included in the one or more server(s) 110 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, game consoles, gaming devices, work stations, media players, digital video recorders (DVRs), set-top boxes, cameras, integrated components for inclusion in a computing device, appliances, or any other sort of computing device.

Device(s) that can be included in the one or more server(s) 110 can include any type of computing device having one or more processing unit(s) (e.g., processor(s) 112) operably connected to computer-readable media 114 such as via a bus, which in some instances can include one or more of a system bus, a data bus, an address bus, a PCI bus, a Mini-PCI bus, and any variety of local, peripheral, and/or independent buses. Executable instructions stored on computer-readable media 114 can include, for example, an input module 116, an identification module 117, an interaction module 118, a presentation module 120, a permissions module 122, one or more applications 124, a database 125, and other modules, programs, or applications that are loadable and executable by the processor(s) 112.

Alternatively, or in addition, the functionality described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Device(s) that can be included in the one or more server(s) 110 can further include one or more input/output (I/O) interface(s) coupled to the bus to allow device(s) to communicate with other devices such as input peripheral devices (e.g., a keyboard, a mouse, a pen, a game controller, a voice input device, a touch input device, gestural input device, a tracking device, a mapping device, an image camera, a depth sensor, a physiological sensor, and the like) and/or output peripheral devices (e.g., a display, a printer, audio speakers, a haptic output, and the like). Such network interface(s) can include one or more network interface controllers (NICs) or other types of transceiver devices to send and receive communications over a network. For simplicity, some components are omitted from the illustrated environment.

Processing unit(s) (e.g., processor(s) 112) can represent, for example, a CPU-type processing unit, a GPU-type processing unit, an HPU-type processing unit, a field-programmable gate array (FPGA), another class of digital signal processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc. In various examples, the processing unit(s) (e.g., processor(s) 112) can execute one or more modules and/or processes to cause the server(s) 110 to perform a variety of functions, as set forth above and explained in further detail in the following disclosure. Additionally, each of the processing unit(s) (e.g., processor(s) 112) can possess its own local memory, which also can store program modules, program data, and/or one or more operating systems.

In at least one configuration, the computer-readable media 114 of the server(s) 110 can include components that facilitate interaction between the service provider 102 and the one or more devices 108. The components can represent pieces of code executing on a computing device. For example, the computer-readable media 114 can include the input module 116, the identification module 117, the interaction module 118, the presentation module 120, the permissions module 122, one or more application(s) 124, and the database 125, etc. In at least some examples, the modules can be implemented as computer-readable instructions, various data structures, and so forth via at least one processing unit(s) (e.g., processor(s) 112) to enable two or more users in a mixed reality environment and/or remote communication environment to interact with one another and cause individual users of the two or more users to be presented with virtual content in the mixed reality environment and/or remote communication environment that corresponds to the individual users. Functionality to perform these operations can be included in multiple devices or a single device.

Depending on the exact configuration and type of the server(s) 110, the computer-readable media 114 can include computer storage media and/or communication media. Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast, communication media can embody computer readable instructions, data structures, program modules, or other data in a modulated data signal, such as a carrier wave, or other transmission mechanism. The term “modulated data signal” means a signal that has one or more of its characteristics set or changed in such a manner as to encode information in the signal. Such signals or carrier waves, etc. can be propagated on wired media such as a wired network or direct-wired connection, and/or wireless media such as acoustic, RF, infrared and other wireless media. As defined herein, computer storage media does not include communication media. That is, computer storage media does not include communications media consisting solely of a modulated data signal, a carrier wave, or a propagated signal, per se.

The input module 116 is configured to receive data from one or more input peripheral devices (e.g., a keyboard, a mouse, a pen, a game controller, a voice input device, a touch input device, gestural input device, a tracking device, a mapping device, an image camera, a video camera, a depth sensor, a physiological sensor, and the like). In some examples, the one or more input peripheral devices can be integrated into the one or more server(s) 110 and/or other machines and/or devices 108. In other examples, the one or more input peripheral devices can be communicatively coupled to the one or more server(s) 110 and/or other machines and/or devices 108. The one or more input peripheral devices can be associated with a single device (e.g., MICROSOFT® KINECT®, INTEL® Perceptual Computing SDK 2013, LEAP MOTION®, etc.) or separate devices.

In at least one example, the input module 116 can be configured to receive streaming data from image capturing devices. Image capturing devices can be input peripheral devices such as image cameras, video cameras, etc., described above, that can capture frames of image data and stream the image data to the input module 116. The input module 116 can send the image data to the devices 108 for rendering.

Additionally and/or alternatively, the input module 116 is configured to receive data associated with positions and orientations of users 106 and their bodies in space (e.g., tracking data). Tracking devices can include optical tracking devices (e.g., VICON®, OPTITRACK®), magnetic tracking devices, acoustic tracking devices, gyroscopic tracking devices, mechanical tracking systems, depth cameras (e.g., KINECT®, INTEL® RealSense, etc.), inertial sensors (e.g., INTERSENSE®, XSENS, etc.), combinations of the foregoing, etc. Tracking data can include two-dimensional tracking data or three-dimensional tracking data. For instance, the tracking devices can output two-dimensional tracking data including motion capture data (e.g., two-dimensional tracking data) that tracks the motion of objects, users (e.g., user 106A, user 106B, and/or user 106C), etc. in substantially real time. Additionally and/or alternatively, the tracking devices can output three-dimensional tracking data, including streams of volumetric data, skeletal data, perspective data, etc. in substantially real time. The streams of volumetric data, skeletal data, perspective data, etc. can be received by the input module 116 in substantially real time.

Volumetric data can correspond to a volume of space occupied by a body of a user (e.g., user 106A, user 106B, or user 106C). Skeletal data can correspond to data used to approximate a skeleton, in some examples, corresponding to a body of a user (e.g., user 106A, user 106B, or user 106C), and track the movement of the skeleton over time. The skeleton corresponding to the body of the user (e.g., user 106A, user 106B, or user 106C) can include an array of nodes that correspond to a plurality of human joints (e.g., elbow, knee, hip, etc.) that are connected to represent a human body. Perspective data can correspond to data collected from two or more perspectives that can be used to determine an outline of a body of a user (e.g., user 106A, user 106B, or user 106C) from a particular perspective. Combinations of the volumetric data, the skeletal data, and the perspective data can be used to determine body representations corresponding to users 106. The body representations can approximate a body shape of a user (e.g., user 106A, user 106B, or user 106C). That is, volumetric data associated with a particular user (e.g., user 106A), skeletal data associated with a particular user (e.g., user 106A), and perspective data associated with a particular user (e.g., user 106A) can be used to determine a body representation that represents the particular user (e.g., user 106A). The body representations can be used by the interaction module 118 to determine interactions between users 106 and/or as a foundation for adding augmentation (i.e., virtual content) to the users 106.

In at least some examples, the input module 116 can receive tracking data associated with real objects. In some examples, the input module 116 can leverage the tracking data to determine object representations corresponding to the objects. That is, volumetric data associated with an object, skeletal data associated with an object, and perspective data associated with an object can be used to determine an object representation that represents the object. The object representations can represent a position and/or orientation of the object in space. As described above, in additional and/or alternative examples, the tracking devices can track the motion of objects in substantially real time and can stream the tracking data to the input module 116.

Additionally, the input module 116 is configured to receive data associated with the real scene that at least one user (e.g., user 106A, user 106B, and/or user 106C) is physically located. The input module 116 can be configured to receive the data from mapping devices associated with the one or more server(s) and/or other machines 110 and/or user devices 108, as described above. The mapping devices can include cameras and/or sensors, as described above. The cameras can include image cameras, stereoscopic cameras, trulight cameras, etc. The sensors can include depth sensors, color sensors, acoustic sensors, pattern sensors, gravity sensors, etc. The cameras and/or sensors can output streams of data in substantially real time. The streams of data can be received by the input module 116 in substantially real time. The data can include moving image data and/or still image data representative of a real scene that is observable by the cameras and/or sensors. Additionally, the data can include depth data.

The depth data can represent distances between real objects in a real scene observable by sensors and/or cameras and the sensors and/or cameras. The depth data can be based at least in part on infrared (IR) data, trulight data, stereoscopic data, light and/or pattern projection data, gravity data, acoustic data, etc. In at least one example, the stream of depth data can be derived from IR sensors (e.g., time of flight, etc.) and can be represented as a point cloud reflective of the real scene. The point cloud can represent a set of data points or depth pixels associated with surfaces of real objects and/or the real scene configured in a three-dimensional coordinate system. The depth pixels can be mapped into a grid. The grid of depth pixels can indicate how far real objects in the real scene are from the cameras and/or sensors. The grid of depth pixels that correspond to the volume of space that is observable from the cameras and/or sensors can be called a depth space. The depth space can be utilized by the rendering module 130 (in the devices 108) for determining how to render virtual content in the mixed reality display. In some examples, the rendering module 130 (in the devices) can render virtual content in the mixed reality display and/or other display device without depth data (e.g., in two-dimensional remote communication service providers).

Additionally, in some examples, the input module 116 can receive physiological data from one or more physiological sensors. The one or more physiological sensors can include wearable devices or other devices that can be used to measure physiological data associated with the users 106. Physiological data can include blood pressure, body temperature, skin temperature, blood oxygen saturation, heart rate, respiration, air flow rate, lung volume, galvanic skin response, etc. Additionally or alternatively, physiological data can include measures of forces generated when jumping or stepping, grip strength, etc.

The identification module 117 is configured to determine unique identifiers associated with individual users (e.g., user 106A, user 106B, user 106C, etc.). Unique identifiers can be phone numbers, user names, etc. associated with individual users (e.g., user 106A, user 106B, user 106C, etc.). A first user (e.g., user 106A) and/or a second user (e.g., user 106B) can initiate a communication via an application (e.g., application(s) 132) on his or her device (e.g., device 108A or device 108B, respectively), via a website, etc. Based at least in part on accessing, receiving, and/or determining data indicating that a communication is initiated, the identification module 117 can access the unique identifiers associated with each of the participants (e.g., the first user (e.g., user 106A) and/or a second user (e.g., user 106B)).

The interaction module 118 is configured to determine whether a first user (e.g., user 106A) and/or object associated with the first user (e.g., user 106A) interacts and/or causes an interaction with a second user (e.g., user 106B) and/or a virtual representation of the second user (e.g., user 106B). Based at least in part on the body representations corresponding to the users 106, the interaction module 118 can determine that a first user (e.g., user 106A) and/or object associated with the first user (e.g., user 106A) interacts and/or causes an interaction with a second user (e.g., user 106B) and/or a virtual representation of the second user (e.g., user 106B). In at least one example, the first user (e.g., user 106A) may interact with the second user (e.g., user 106B) and/or a virtual representation of the second user (e.g., user 106B) via a body part (e.g., finger, hand, leg, etc.). In at least one example, the interaction module 118 can determine that the first user (e.g., user 106A) interacts with the second user (e.g., user 106B) and/or a virtual representation of the second user (e.g., user 106B) based at least in part on determining that the body representation corresponding to the first user (e.g., user 106A) is within a threshold distance of a body representation corresponding to the second user (e.g., user 106B). In another example, the interaction module 118 can determine that the first user (e.g., user 106A) interacts with the second user (e.g., user 106B) based at least in part on determining that a body part (e.g., finger, hand, leg, etc.) is within a threshold distance of a body representation corresponding to the second user (e.g., user 106B), is in contact with a body representation corresponding to the second user (e.g., user 106B) for a threshold amount of time, etc. Additionally and/or alternatively, the interaction module 118 can determine that the first user (e.g., user 106A) interacts with the second user (e.g., user 106B) based at least in part on determining that a body part (e.g., finger, hand, leg, etc.) touches a portion of a touchscreen display corresponding to a virtual representation of the second user (e.g., user 106B).

In other examples, the interaction module 118 can determine that the first user (e.g., user 106A) interacts with the second user (e.g., user 106B) via an extension of at least one of the first user (e.g., user 106A) or the second user (e.g., user 106B). The extension can include a real object or a virtual object associated with at least one of the first user (e.g., user 106A) or the second user (e.g., user 106B). As non-limiting examples, the extension can be an input peripheral device (e.g., a mouse, a pen, a game controller, a voice input device, a touch input device, gestural input device, etc.). In an example where the first user (e.g., user 106A) interacts with the second user (e.g., user 106B) via a real object, the interaction module 118 can leverage the tracking data (e.g., object representation) and/or mapping data associated with the real object to determine that the real object (i.e., the object representation corresponding to the real object) is within a threshold distance of the body representation corresponding to the second user (e.g., user 106B), is in contact with a portion of a display associated with a virtual representation corresponding to the second user (e.g., user 106B), etc. In an example where the first user (e.g., user 106A) interacts with the second user (e.g., user 106B) via a virtual object, the interaction module 118 can leverage data (e.g., volumetric data, skeletal data, perspective data, etc.) associated with the virtual object to determine that the object representation corresponding to the virtual object is within a threshold distance of the body representation corresponding to the second user (e.g., user 106B), is in contact with a portion of a display associated with a virtual representation corresponding to the second user (e.g., user 106B), etc.

The presentation module 120 is configured to send rendering data to devices 108 for presenting virtual content via the devices 108. Based at least in part on determining that the first user (e.g., user 106A) interacts with the second user (e.g., user 106B), the presentation module 120 can access data associated with instructions for rendering virtual content that is associated with at least one of the first user (e.g., user 106A) or the second user (e.g., user 106B). The instructions can be determined by the one or more applications 126 and/or 132.

The permissions module 122 is configured to determine whether an interaction between a first user (e.g., user 106A) and the second user (e.g., user 106B) is permitted, authorizations associated with individual users (e.g., user 106A, user 106B, user 106C, etc.), etc. In at least one example, the permissions module 122 can store permissions data corresponding to instructions associated with individual users 106. The instructions can indicate what interactions that a particular user (e.g., user 106A, user 106B, or user 106C) permits another user (e.g., user 106A, user 106B, or user 106C) to have with the particular user (e.g., user 106A, user 106B, or user 106C) and/or view of the particular user (e.g., user 106A, user 106B, or user 106C). Additionally and/or alternatively, permission data can indicate certain body regions where a particular user (e.g., user 106A, user 106B, or user 106C) is permitted to interact with another user (e.g., user 106A, user 106B, or user 106C) and/or certain body regions where a user (e.g., user 106A, user 106B, or user 106C) allows others to augment his or her body in the MR display. Moreover, the permission module 122 can determine permissions associated with which user (e.g., user 106A, user 106B, or user 106C) can remove virtual content that is associated with a user (e.g., user 106A, user 106B, or user 106C). The permissions data can be mapped to unique identifiers that are stored in the database 125, described below.

For instance, in a non-limiting example, a user (e.g., user 106A, user 106B, or user 106C) can be offended by a particular logo, color, etc. Accordingly, the user (e.g., user 106A, user 106B, or user 106C) may indicate that other users 106 cannot augment the user (e.g., user 106A, user 106B, or user 106C) with the particular logo, color, etc. Alternatively or additionally, the user (e.g., user 106A, user 106B, or user 106C) may be embarrassed by a particular application or virtual content item. Accordingly, the user (e.g., user 106A, user 106B, or user 106C) can indicate that other users 106 cannot augment the user (e.g., user 106A, user 106B, or user 106C) using the particular application and/or with the particular piece of virtual content. Or, a user (e.g., user 106A, user 106B, or user 106C) can permit other user's (e.g., user 106A, user 106B, or user 106C) to augment their hands and/or arms but not their face and/or torso.

Applications (e.g., application(s) 124) are created by programmers to fulfill specific tasks. For example, applications (e.g., application(s) 124) can provide utility, entertainment, and/or productivity functionalities to users 106 of devices 108. Applications (e.g., application(s) 124) can be built into a device (e.g., telecommunication, text message, clock, camera, etc.) or can be customized (e.g., games, news, transportation schedules, online shopping, etc.). Application(s) 124 can provide conversational partners (e.g., two or more users 106) various functionalities, including but not limited to, visualizing one another in mixed reality environments and/or remote communication environments, share joint sensory experiences in same and/or remote environments, adding, removing, modifying, etc. markings to body representations associated with the users 106, viewing biological signals associated with other users 106 in the mixed reality environments and/or remote communication environments, etc., as described above.

The database 125 can store data associated with individual users (e.g., user 106A, user 106B, user 106C, etc.). Each user (e.g., user 106A, user 106B, user 106C, etc.) can be associated with a unique identifier and each unique identifier can be mapped to different data, including, but not limited to, data associated with virtual content that is associated with a user (e.g., user 106A, user 106B, or user 106C) corresponding to the unique identifier. For instance, if a first user (e.g., user 106A) interacts with a virtual representation of a second user (e.g., user 106B) such to place a virtual BAND-AID® on the virtual representation of the second user (e.g., user 106B), data associated with virtual content associated with a BAND-AID® and data indicating a position on the virtual representation of the second user (e.g., user 106B) the BAND-AID® is rendered (e.g., global coordinate data, skeleton tracking data, etc.) can be mapped to the unique identifier corresponding to the second user (e.g., user 106B). That is, unique identifiers can be stored in the database 125 with data indicating virtual content associated with a unique identifier, data indicating position and/or orientation of the virtual content, data indicating the expiration of the virtual content (i.e., a predetermined amount of time that the virtual content persists), etc. Additionally and/or alternatively, permissions data can be mapped to individual unique identifiers for determining permissions as described above.

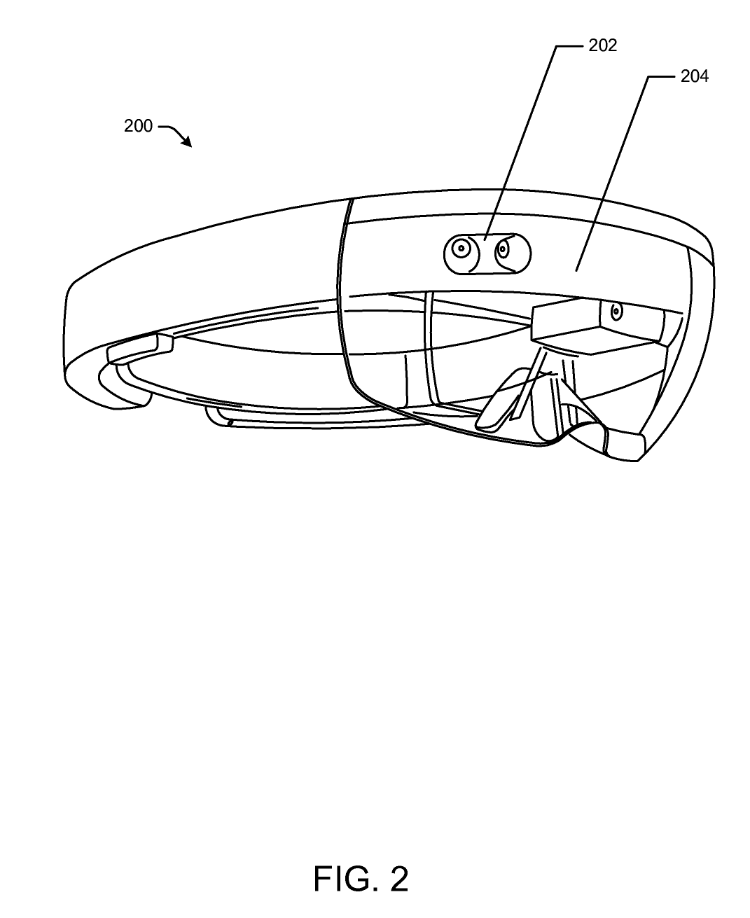

In some examples, the one or more users 106 can operate corresponding devices 108 (e.g., user devices 108) to perform various functions associated with the devices 108. Device(s) 108 can represent a diverse variety of device types and are not limited to any particular type of device. Examples of device(s) 108 can include but are not limited to stationary computers, mobile computers, embedded computers, or combinations thereof. Example stationary computers can include desktop computers, work stations, personal computers, thin clients, terminals, game consoles, personal video recorders (PVRs), set-top boxes, or the like. Example mobile computers can include laptop computers, tablet computers, wearable computers, implanted computing devices, telecommunication devices, automotive computers, portable gaming devices, media players, cameras, or the like. Example embedded computers can include network enabled televisions, integrated components for inclusion in a computing device, appliances, microcontrollers, digital signal processors, or any other sort of processing device, or the like. In at least one example, the devices 108 can include mixed reality devices (e.g., CANON® MREAL® System, MICROSOFT® HOLOLENS®, etc.). Mixed reality devices can include one or more sensors and a mixed reality display, as described below in the context of FIG. 2. In FIG. 1, device 108A and device 108B are wearable computers (e.g., head mount devices); however, device 108A and/or device 108B can be any other device as described above. Similarly, in FIG. 1, device 108C is a mobile computer (e.g., a tablet); however, device 108C can be any other device as described above.

Device(s) 108 can include one or more input/output (I/O) interface(s) coupled to the bus to allow device(s) to communicate with other devices such as input peripheral devices (e.g., a keyboard, a mouse, a pen, a game controller, a voice input device, a touch input device, gestural input device, a tracking device, a mapping device, an image camera, a video camera, a depth sensor, a physiological sensor, and the like) and/or output peripheral devices (e.g., a display, a printer, audio speakers, a haptic output, and the like). As described above, in some examples, the I/O devices can be integrated into the one or more server(s) 110 and/or other machines and/or devices 108. In other examples, the one or more input peripheral devices can be communicatively coupled to the one or more server(s) 110 and/or other machines and/or devices 108. The one or more input peripheral devices can be associated with a single device (e.g., MICROSOFT® KINECT®, INTEL® Perceptual Computing SDK 2013, LEAP MOTION®, etc.) or separate devices.

FIG. 2 is a schematic diagram showing an example of a head mounted mixed reality display device 200. As illustrated in FIG. 2, the head mounted mixed reality display device 200 can include one or more sensors 202 and a display 204. The one or more sensors can include image capturing devices. The one or more sensors 202 can include tracking technology, including but not limited to, depth cameras and/or sensors, inertial sensors, optical sensors, etc., as described above. Additionally or alternatively, the one or more sensors 202 can include one or more physiological sensors for measuring a user's heart rate, breathing, skin conductance, temperature, etc. In some examples, as illustrated in FIG. 2, the one or more sensors 202 can be mounted on the head mounted mixed reality display device 200. The one or more sensors 202 correspond to inside-out sensing sensors; that is, sensors that capture information from a first person perspective. In additional or alternative examples, the one or more sensors can be external to the head mounted mixed reality display device 200 and/or devices 108. In such examples, the one or more sensors can be arranged in a room (e.g., placed in various positions throughout the room), associated with a device, etc. Such sensors can correspond to outside-in sensing sensors; that is, sensors that capture information from a third person perspective. In yet another example, the sensors can be external to the head mounted mixed reality display device 200 but can be associated with one or more wearable devices configured to collect data associated with the user (e.g., user 106A, user 106B, or user 106C).

In FIG. 2, the display 204 can present visual content to the one or more users 106 in a mixed reality environment. In some examples, the display 204 can present the mixed reality environment to the user (e.g., user 106A, user 106B, or user 106C) in a spatial region that occupies an area that is substantially coextensive with a user's (e.g., user 106A, user 106B, or user 106C) actual field of vision. In other examples, the display 204 can present the mixed reality environment to the user (e.g., user 106A, user 106B, or user 106C) in a spatial region that occupies a lesser portion of a user's (e.g., user 106A, user 106B, or user 106C) actual field of vision. The display 204 can include a transparent display that enables a user (e.g., user 106A, user 106B, or user 106C) to view the real scene where he or she is physically located. Transparent displays can include optical see-through displays where the user (e.g., user 106A, user 106B, or user 106C) sees the real scene he or she is physically present in directly, video see-through displays where the user (e.g., user 106A, user 106B, or user 106C) observes the real scene in a video image acquired from a mounted camera, etc. The display 204 can present the virtual content to a user (e.g., user 106A, user 106B, or user 106C) such that the virtual content augments the real scene where the user (e.g., user 106A, user 106B, or user 106C) is physically located within the spatial region.

The virtual content can appear differently to different users (e.g., user 106A, user 106B, and/or user 106C) based on the users' perspectives and/or the location of the devices (e.g., device 108A, device 108B, and/or device 108C). For instance, the size of a virtual content item can be different based on a proximity of a user (e.g., user 106A, user 106B, and/or user 106C) and/or device (e.g., device 108A, device 108B, and/or device 108C) to a virtual content item. Additionally or alternatively, the shape of the virtual content item can be different based on the vantage point of a user (e.g., user 106A, user 106B, and/or user 106C) and/or device (e.g., device 108A, device 108B, and/or device 108C). For instance, a virtual content item can have a first shape when a user (e.g., user 106A, user 106B, and/or user 106C) and/or device (e.g., device 108A, device 108B, and/or device 108C) is looking at the virtual content item straight on and may have a second shape when a user (e.g., user 106A, user 106B, and/or user 106C) and/or device (e.g., device 108A, device 108B, and/or device 108C) is looking at the virtual item from the side.

Returning to FIG. 1, device 108C is illustrated with a sensor 202 and display 204 that are configured to perform functions described above in the context of FIG. 2. In FIG. 1, the sensor 202 can include image capturing devices, tracking technology, etc., as described above. The display 204 can present a virtual representation of a remotely located user (e.g., user 106A, user 106B, or user 106C). In at least one example, a device (e.g., 108A, 108B, or 108C) associated with the remotely located user (e.g., user 106A, user 106B, or user 106C) can send image data to the device (e.g., 108A, 108B, or 108C) associated with the user (e.g., user 106A, user 106B, or user 106C) and the rendering module 130 associated with the device (e.g., 108A, 108B, or 108C) associated with the user (e.g., user 106A, user 106B, or user 106C) can generate a virtual representation of the remotely located user (e.g., user 106A, user 106B, or user 106C) on the display 204 of a device associated with the user (e.g., user 106A, user 106B, or user 106C). In some examples, the virtual representation of the remotely located user (e.g., user 106A, user 106B, or user 106C) can be a two-dimensional representation or a three-dimensional representation, depending on the sensors 202 associated with the devices (e.g., device 108A, device 108B, or device 108C). In at least one example, the display 204 can be a video display where the user (e.g., user 106A, user 106B, or user 106C) observes a video image acquired from an image capturing device, associated with a remotely located user (e.g., user 106A, user 106B, or user 106C). The display 204 can present the virtual content to a user (e.g., user 106A, user 106B, or user 106C) such that the virtual content augments the virtual representation of the remotely located user (e.g., user 106A, user 106B, or user 106C) and/or the real scene where the remotely located user (e.g., user 106A, user 106B, or user 106C) is physically located.

The devices 108 can include one or more processing unit(s) (e.g., processor(s) 126), computer-readable media 128, at least including a rendering module 130, and one or more applications 132. The one or more processing unit(s) (e.g., processor(s) 126) can represent same units and/or perform same functions as processor(s) 112, described above. Computer-readable media 128 can represent computer-readable media 114 as described above. Computer-readable media 128 can include components that facilitate interaction between the service provider 102 and the one or more devices 108. The components can represent pieces of code executing on a computing device, as described above. Computer-readable media 128 can include at least a rendering module 130. The rendering module 130 can receive rendering data from the service provider 102. In some examples, the rendering module 130 may utilize the rendering data to render virtual content via a processor 126 (e.g., a GPU) on the device (e.g., device 108A, device 108B, or device 108C). In other examples, the service provider 102 may render the virtual content and may send a rendered result as rendering data to the device (e.g., device 108A, device 108B, or device 108C). The device (e.g., device 108A, device 108B, or device 108C) may present the rendered virtual content on the display 204. Application(s) 132 can correspond to same applications as application(s) 128 or different applications.

Example Mixed Reality and/or Remote Communication User Interfaces

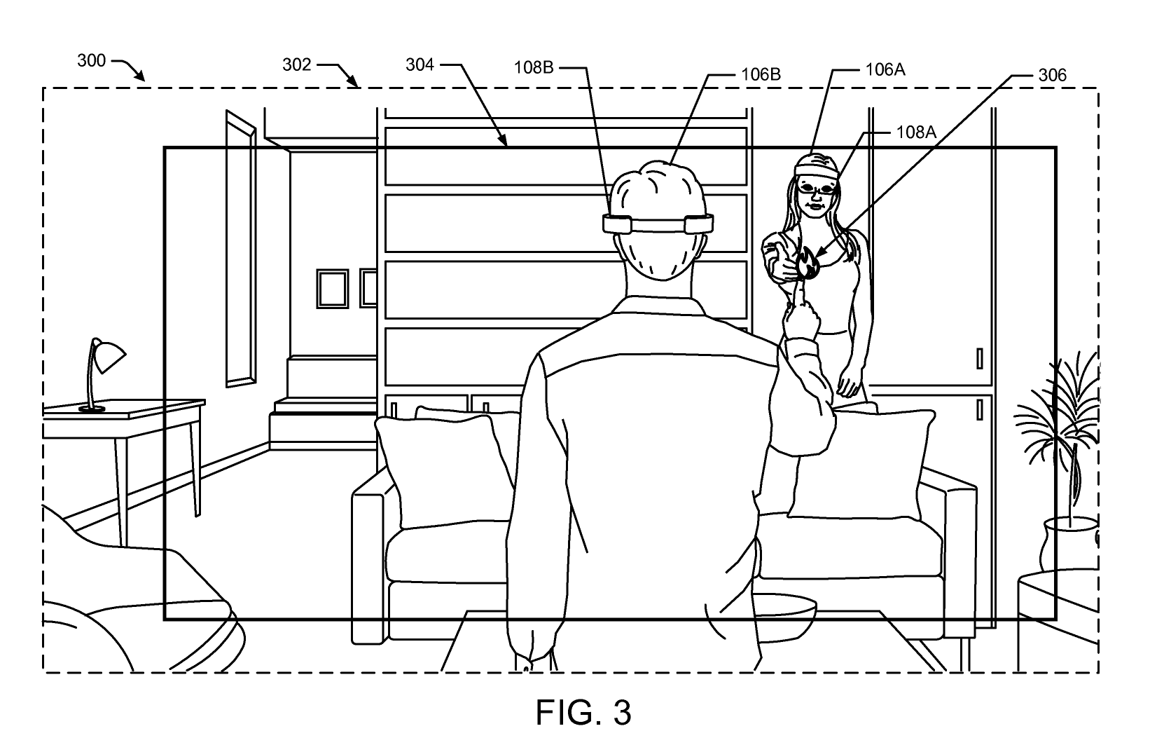

FIGS. 3, 4, 7A, 7B, 8A, and 8B are non-limiting examples of user interfaces that can be generated to enhance social interactions in mixed reality and/or remote communication environments. Additional and/or alternative configurations of the user interface and/or virtual content described herein can be used.

FIG. 3 is a schematic diagram 300 showing an example of a third person view of two users (e.g., user 106A and user 106B) interacting in a mixed reality environment. The area depicted in the dashed lines corresponds to a real scene 302 in which at least one of a first user (e.g., user 106A) or a second user (e.g., user 106B) is physically present. In some examples, both the first user (e.g., user 106A) and the second user (e.g., user 106B) are physically present in the real scene 302. In other examples, one of the users (e.g., user 106A or user 106B) can be physically present in another real scene and can be virtually present in the real scene 302. In such an example, the device (e.g., device 108A) associated with the physically present user (e.g., user 106A) can receive streaming data for rendering a virtual representation of the other user (e.g., user 106B) in the real scene where the user (e.g., user 106A) is physically present in the mixed reality environment. In yet other examples, one of the users (e.g., user 106A or user 106B) can be physically present in another real scene and may not be present in the real scene 302. For instance, in such examples, a first user (e.g., user 106A) and/or an object associated with the first user (e.g., user 106A) may interact with via a device (e.g., device 108A) with a remotely located second user (e.g., user 106B).

FIG. 3 presents a third person point of view of a user (e.g., user 106C) that is not involved in the interaction. The area depicted in the solid black line corresponds to the spatial region 304 in which the mixed reality environment is visible to a user (e.g., user 106C) via a display 204 of a corresponding device (e.g., device 108C). As described above, in some examples, the spatial region can occupy an area that is substantially coextensive with a user's (e.g., user 106C) actual field of vision and in other examples, the spatial region can occupy a lesser portion of a user's (e.g., user 106C) actual field of vision.

In FIG. 3, the first user (e.g., user 106A) contacts the second user (e.g., user 106B). As described above, the interaction module 118 can leverage body representations associated with the first user (e.g., user 106A) and the second user (e.g., user 106B) to determine that the first user (e.g., user 106A) interacts with the second user (e.g., user 106B). Based at least in part on determining that the first user (e.g., user 106A) interacts with the second user (e.g., user 106B), the presentation module 120 can send rendering data to the devices (e.g., device 108A, device 108B, and device 108C) to present virtual content in the mixed reality environment. The virtual content can be associated with one or more applications 124 and/or 132.

In the example of FIG. 3, the application can be associated with causing a virtual representation of a flame 306 to appear in a position consistent with where the first user (e.g., user 106A) contacts the second user (e.g., user 106B). In additional or alternative examples, an application 124 and/or 132 can be associated with causing a virtual representation corresponding to a sticker, a tattoo, an accessory, etc. to be presented. The virtual representation corresponding to the sticker, the tattoo, the accessory, etc. can conform to the first body representation and/or the second body representation at a position on the first body representation and/or the second body representation corresponding to wherein the first user (e.g., user 106A) contacts the second user (e.g., user 106B). For the purposes of this discussion, virtual content conforms to a body representation by being rendered such to augment a corresponding user (e.g., the first user (e.g., user 106A) or second user (e.g., user 106B)) pursuant to the volumetric data, skeletal data, and/or perspective data that comprises the body representation. The virtual content can track with the body representation such that the virtual content can move consistent with the movement of the corresponding user (e.g., the first user (e.g., user 106A) or second user (e.g., user 106B)).

In some examples, an application can be associated with causing a virtual representation corresponding to a color change to be presented. In other examples, an application can be associated with causing a graphical representation of physiological data associated with the first user (e.g., user 106A) and/or the second user (e.g., user 106B) to be presented by augmenting the first user (e.g., user 106A) and/or the second user (e.g., user 106B) in the mixed reality environment.

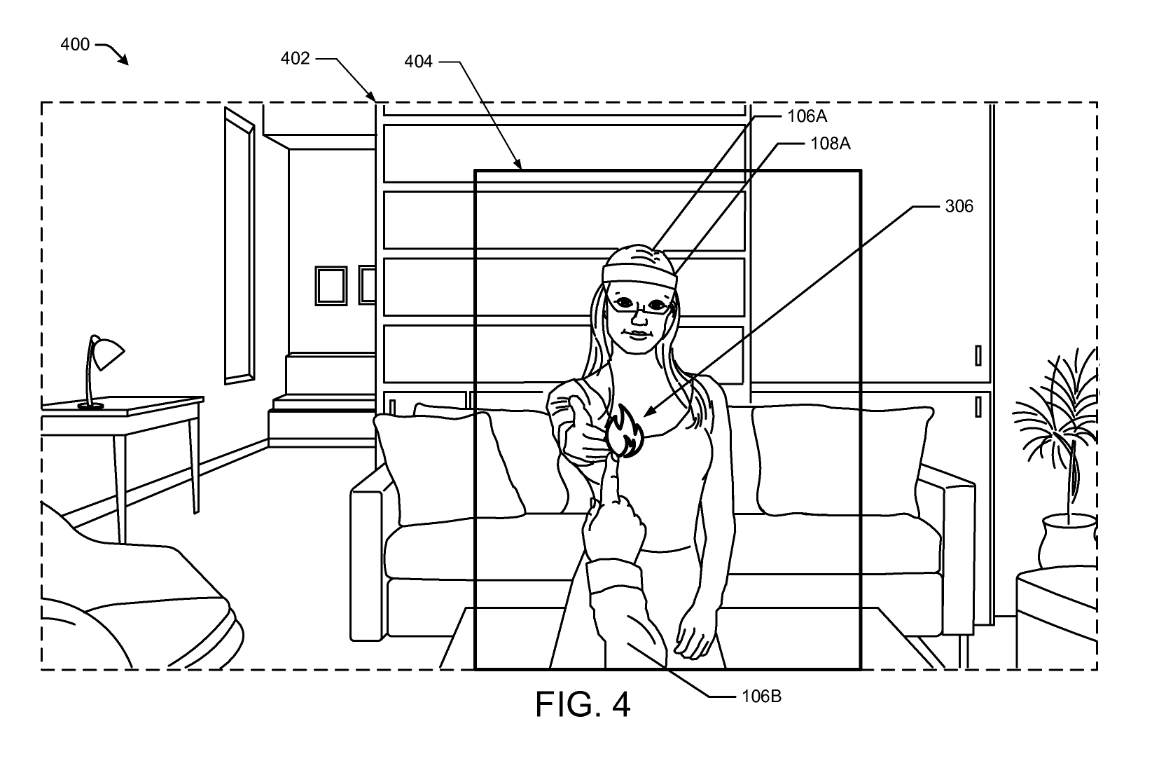

FIG. 4 is a schematic diagram 400 showing an example of a first person view of a user (e.g., user 106A) interacting with another user (e.g., user 106B) in a mixed reality environment. The area depicted in the dashed lines corresponds to a real scene 402 in which at least one of a first user (e.g., user 106A) or a second user (e.g., user 106B) is physically present. In some examples, both the first user (e.g., user 106A) and the second user (e.g., user 106B) are physically present in the real scene 402. In other examples, one of the users (e.g., user 106A or user 106B) can be physically present in another real scene and can be virtually present in the real scene 402, as described above. FIG. 4 presents a first person point of view of a user (e.g., user 106B) that is involved in the interaction. The area depicted in the solid black line corresponds to the spatial region 404 in which the mixed reality environment is visible to a user (e.g., user 106C) via a display 204 of a corresponding device (e.g., device 108C). As described above, in some examples, the spatial region 404 can occupy an area that is substantially coextensive with a user's (e.g., user 106A, user 106B, or user 106C) actual field of vision and in other examples, the spatial region can occupy a lesser portion of a user's (e.g., user 106A, user 106B, or user 106C) actual field of vision. In at least one example, the spatial region 404 can correspond to a display 204 of a device (e.g., device 108C).

In FIG. 4, the first user (e.g., user 106A) contacts the second user (e.g., user 106B). As described above, the interaction module 118 can leverage body representations associated with the first user (e.g., user 106A) and the second user (e.g., user 106B) to determine that the first user (e.g., user 106A) interacts with the second user (e.g., user 106B). Based at least in part on determining that the first user (e.g., user 106A) interacts with the second user (e.g., user 106B), the presentation module 120 can send rendering data to the devices (e.g., device 108A and device 108B) to present virtual content in the mixed reality environment. The virtual content can be associated with one or more applications 124 and/or 132. In the example of FIG. 4, the application 124 and/or 132 can be associated with causing a virtual representation of a flame 306 to appear in a position consistent with where the first user (e.g., user 106A) contacts the second user (e.g., user 106B). Additional and/or alternative applications can cause additional and/or alternative virtual content to be presented to the first user (e.g., user 106A) and/or the second user (e.g., user 106B) via corresponding devices 108. As described above, the virtual content can track with the body representation such that the virtual content can move consistent with the movement of the corresponding user (e.g., the first user (e.g., user 106A) or second user (e.g., user 106B)).

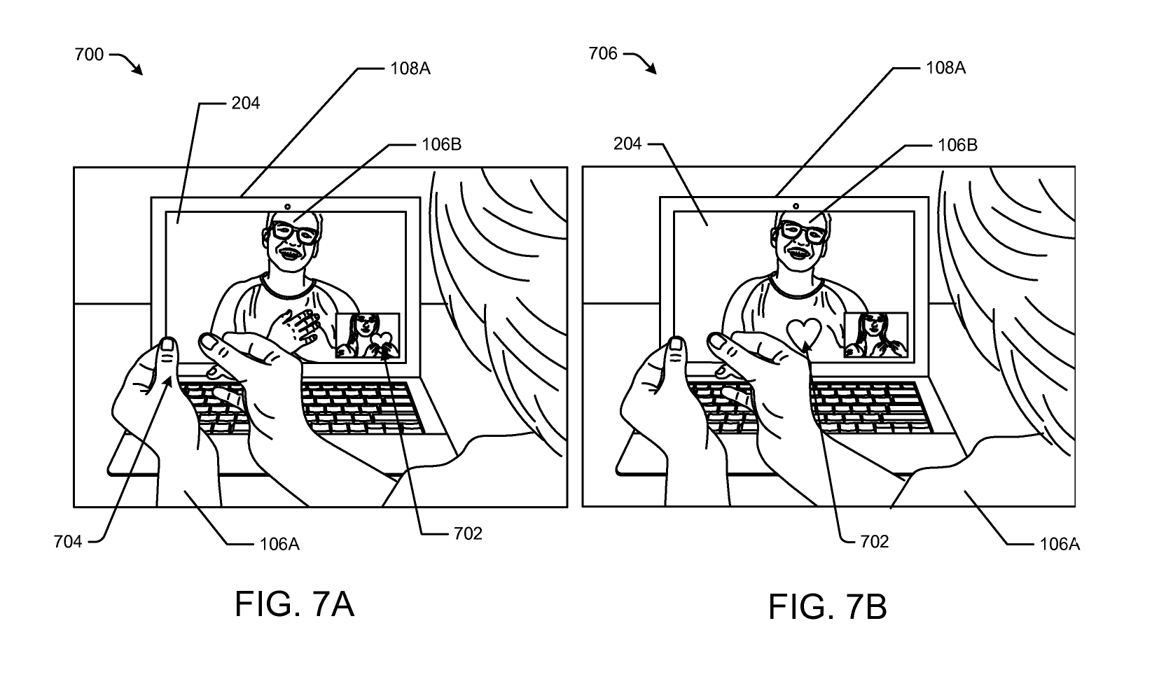

FIG. 7A is a schematic diagram 700 showing an example of a third person view of two users (e.g., user 106A and user 106B) interacting in a remote communication environment. As illustrated in FIG. 7A, a first user (e.g., user 106A) is physically present in a real scene. The first user (e.g., user 106A) is communicating with a second user (e.g., user 106B) in a remote communication environment via a corresponding device (e.g., device 108A). The second user (e.g., user 106B) is not physically present in the real scene but rather is virtually present on the display 204 of the device (e.g., device 108A) via a virtual representation that corresponds to the second user (e.g., user 106B). In FIG. 7A, the first user (e.g., user 106A) is interacting with a virtual heart 702 via movement of her hands 704.

FIG. 7B is a schematic diagram 706 showing an example of a third person view of two users (e.g., user 106A and user 106B) interacting in a remote communication environment. In FIG. 7B, the first user (e.g., user 106A) can touch the display 204 with his or her finger (or other body part) and/or leverage an input peripheral device including, but not limited to, a mouse, a pen, a game controller, a voice input device, a touch input device, gestural input device, etc. to place the virtual heart 702 on a virtual representation of the second user (e.g., user 106B). For instance, the first user (e.g., user 106A) can touch a portion of a touchscreen display corresponding to the virtual representation of the second user (e.g., user 106B) and, based at least in part on determining the interaction, the rendering module 130 can render a virtual heart 702 on the virtual representation of the second user (e.g., user 106B) in a position on the virtual representation that corresponds to where the first user (e.g., user 106A) touched the portion of a touchscreen display corresponding to the virtual representation of the second user (e.g., user 106B). In other examples, as described above, the first user (e.g., user 106A) can hover the virtual heart 702 over the position on the virtual representation of the second user (e.g., user 106B) that the first user (e.g., user 106A) desires to place the virtual heart 702 for a threshold amount of time to trigger an interaction and cause the rendering module 130 to render the virtual heart 702 on the virtual representation of the second user (e.g., user 106B) in the position on the virtual representation that corresponds to where the first user (e.g., user 106A) hovered the virtual heart 702.

The data associated with the virtual content (e.g., virtual heart 702), the position and/or orientation of the virtual content (e.g., virtual heart 702), and/or additional data can be associated with a unique identifier associated with the first user (e.g., user 106A) and/or the second user (e.g., user 106B) in database 125. The virtual heart 702 can persist until the first user (e.g., user 106A) and/or the second user (e.g., user 106B) removes the virtual heart 702 and/or the virtual heart 702 expires. In at least one example, based at least in part on the permissions data associated with the unique identifiers, each time the first user (e.g., user 106A) and the second user (e.g., user 106B) initiate a communication, the virtual heart 702 can be rendered on the display(s) 204 in a same position and/or orientation as where it was rendered in a previous communication until the heart 702 is removed and/or expires.

The virtual heart 702 can track with the movement of the second user (e.g., user 106B). For instance, if the second user (e.g., user 106B) moves around in the real scene where the second user (e.g., user 106B) is located, the virtual heart 702 can move with the second user (e.g., user 106B) and maintain its position relative to the virtual representation of the second user (e.g., user 106B).

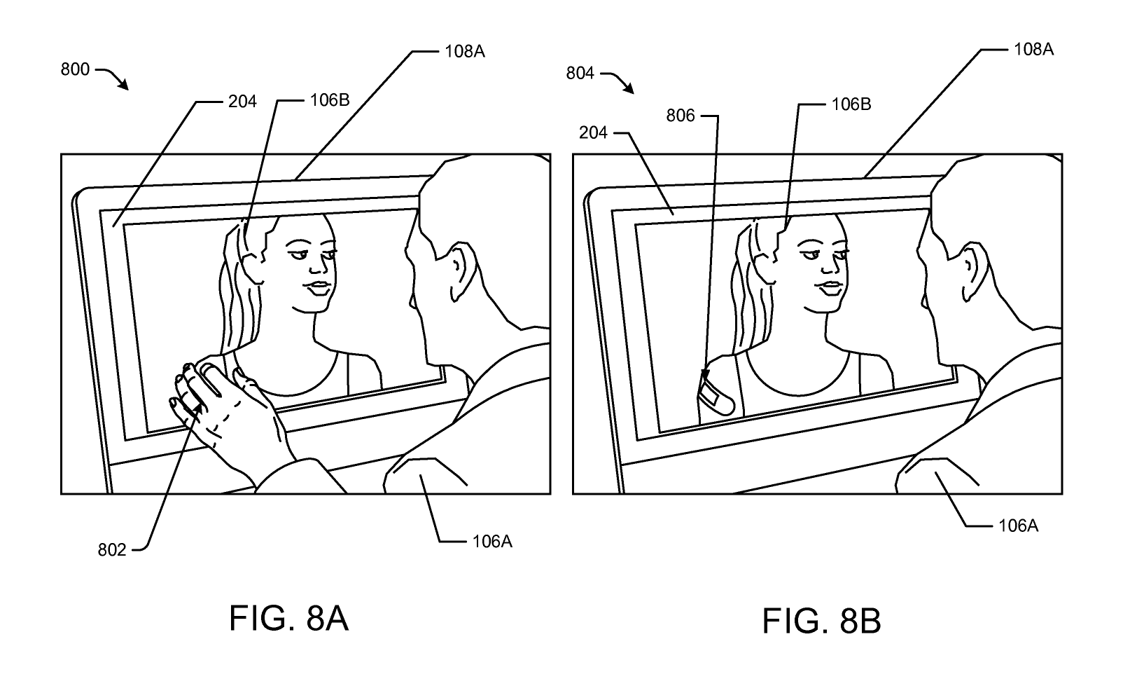

FIG. 8A is a schematic diagram 800 showing an example of a third person view of two users (e.g., user 106A and user 106B) interacting in a remote communication environment. As illustrated in FIG. 8A, a first user (e.g., user 106A) is physically present in a real scene. The first user (e.g., user 106A) is communicating with a second user (e.g., user 102B) in a remote communication environment via a corresponding device (e.g., device 108A). The second user (e.g., user 106B) is not physically present in the real scene but rather is virtually present on the display 204 of the device (e.g., device 108A) via a virtual representation that corresponds to the second user (e.g., user 106B). In FIG. 8A, the first user (e.g., user 106A) is touching 802 a portion of the display 204 corresponding to the virtual representation of the second user (e.g., user 106B) that is presented on the display 204 of the device (e.g., device 108A).

In FIG. 8A, the first user (e.g., user 106A) can touch the display 204 and/or leverage an input peripheral device including, but not limited to, a mouse, a pen, a game controller, a voice input device, a touch input device, gestural input device, etc. to place a virtual BAND-AID® on a virtual representation of the second user (e.g., user 106B). For instance, the first user (e.g., user 106A) can touch the portion of a touchscreen that corresponds to the virtual representation of the second user (e.g., user 106B) and, based at least in part on determining the interaction, the rendering module 130 can render a virtual BAND-AID® on the virtual representation of the second user (e.g., user 106B) in a position on the virtual representation that corresponds to where the first user (e.g., user 106A) touched the virtual representation of the second user (e.g., user 106B). In some examples, the position on the virtual representation of the second user (e.g., user 106B) can correspond to a position on the second user (e.g., user 106B) that the second user (e.g., user 106B) has a cut, scrape, etc. FIG. 8B is a schematic diagram 804 showing an example of a third person view of two users (e.g., user 106A and user 106B) interacting in a remote communication environment. FIG. 8B illustrates a virtual representation of the second user (e.g., user 106B) with a virtual BAND-AID® 806 rendered on the virtual representation of the second user (e.g., user 106B) on the display 204.

The data associated with the virtual content (e.g., virtual BAND-AID® 806), the position and orientation of the virtual content (e.g., virtual BAND-AID® 806), and/or additional data can be mapped to a unique identifier associated with the first user (e.g., user 106A) and/or second user (e.g., user 106B) in database 125. The virtual BAND-AID® 806 can persist until the first user (e.g., user 106A) and/or the second user (e.g., user 106B) removes the virtual BAND-AID® 806 and/or the virtual BAND-AID® expires. For instance, each time the first user (e.g., user 106A) and the second user (e.g., user 106B) activate a remote communication environment, unless and until the virtual BAND-AID® 806 is removed or expires, the virtual BAND-AID® 806 can be rendered on the virtual representation of the second user (e.g., user 106B). The virtual BAND-AID® 806 can track with the movement of the second user (e.g., user 106B). For instance, if the second user (e.g., user 106B) moves around in the real scene where the second user (e.g., user 106B) is located, the virtual BAND-AID® 806 can move with the second user (e.g., user 106) and maintain its position relative to the virtual representation of the second user (e.g., user 106B).

### Example Processes

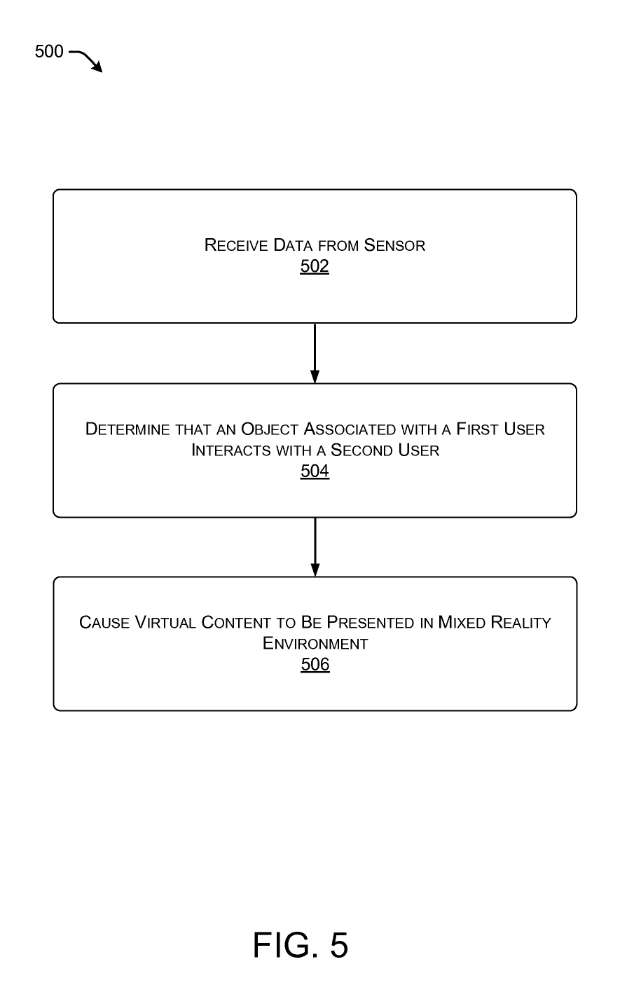

The processes described in FIGS. 5, 6, 9, and 10 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 5 is a flow diagram that illustrates an example process 500 to cause virtual content to be presented in a mixed reality environment via a mixed reality display device (e.g., device 108A, device 108B, and/or device 108C).

Block 502 illustrates receiving data from a sensor (e.g., sensor 202). As described above, in at least one example, the input module 116 is configured to receive data associated with positions and orientations of users 106 and their bodies in space (e.g., tracking data). Tracking devices can output streams of volumetric data, skeletal data, perspective data, etc. in substantially real time. Combinations of the volumetric data, the skeletal data, and the perspective data can be used to determine body representations corresponding to users 106 (e.g., compute the representations via the use of algorithms and/or models). That is, volumetric data associated with a particular user (e.g., user 106A), skeletal data associated with a particular user (e.g., user 106A), and perspective data associated with a particular user (e.g., user 106A) can be used to determine a body representation that represents the particular user (e.g., user 106A). In at least one example, the volumetric data, the skeletal data, and the perspective data can be used to determine a location of a body part associated with each user (e.g., user 106A, user 106B, user 106C, etc.) based on a simple average algorithm in which the input module 116 averages the position from the volumetric data, the skeletal data, and/or the perspective data. The input module 116 may utilize the various locations of the body parts to determine the body representations. In other examples, the input module 116 can utilize a mechanism such as a Kalman filter, in which the input module 116 leverages past data to help predict the position of body parts and/or the body representations. In additional or alternative examples, the input module 116 may leverage machine learning (e.g. supervised learning, unsupervised learning, neural networks, etc.) on the volumetric data, the skeletal data, and/or the perspective data to predict the positions of body parts and/or body representations. The body representations can be used by the interaction module 118 to determine interactions between users 106 and/or as a foundation for adding augmentation to the users 106 in the mixed reality environment.

Block 504 illustrates determining that an object associated with a first user (e.g., user 106A) interacts with a second user (e.g., user 106B). The interaction module 118 is configured to determine that an object associated with a first user (e.g., user 106A) interacts with a second user (e.g., user 106B). The interaction module 118 can determine that the object associated with the first user (e.g., user 106A) interacts with the second user (e.g., user 106B) based at least in part on the body representations corresponding to the users 106. In at least some examples, the object can correspond to a body part of the first user (e.g., user 106A). In such examples, the interaction module 118 can determine that the first user (e.g., user 106A) interacts with the second user (e.g., user 106B) based at least in part on determining that a first body representation corresponding to the first user (e.g., user 106A) is within a threshold distance of a second body representation corresponding to the second user (e.g., user 106B). In other examples, the interaction module 118 can determine that the first user (e.g., user 106A) interacts with the second user (e.g., user 106B) via an extension of at least one of the first user (e.g., user 106A) or the second user (e.g., user 106B), as described above. The extension can include a real object or a virtual object associated with at least one of the first user (e.g., user 106A) or the second user (e.g., user 106B), as described above.

In some examples, the first user (e.g., user 106A) can cause an interaction between the first user (e.g., user 106A) and/or an object associated with the first user (e.g., user 106A) and the second user (e.g., user 106B). In such examples, the first user (e.g., user 106A) can interact with a real object or virtual object such to cause the real object or virtual object and/or an object associated with the real object or virtual object to contact the second user (e.g., user 106B). As a non-limiting example, the first user (e.g., user 106A) can fire a virtual paintball gun with virtual paintballs at the second user (e.g., user 106B). If the first user (e.g., user 106A) contacts the body representation of the second user (e.g., 106B) with the virtual paintballs, the interaction module 118 can determine that the first user (e.g., user 106A) caused an interaction between the first user (e.g., user 106A) and the second user (e.g., user 106B) and can render virtual content on the body representation of the second user (e.g., user 106B) in the mixed reality environment, as described below.

Block 506 illustrates causing virtual content to be presented in a mixed reality environment. The presentation module 120 is configured to send rendering data to devices 108 for presenting virtual content via the devices 108. Based at least in part on determining that the first user (e.g., user 106A) interacts with the second user (e.g., user 106B), the presentation module 120 can access data associated with instructions for rendering virtual content that is associated with at least one of the first user (e.g., user 106A) or the second user (e.g., user 106B) in the mixed reality environment. The instructions can be determined by the one or more applications 124 and/or 132. In at least one example, the presentation module 120 can access data stored in the permissions module 122 to determine whether the interaction is permitted. The rendering module(s) 130 associated with a first device (e.g., device 108A) and/or a second device (e.g., device 108B) can receive rendering data from the service provider 102 and can utilize one or more rendering algorithms to render virtual content on the display 204 of the first device (e.g., device 108A) and/or a second device (e.g., device 108B). The virtual content can conform to the body representations associated with the first user (e.g., user 106A) and/or the second user (e.g., user 106B) so as to augment the first user (e.g., user 106A) and/or the second user (e.g., user 106B). Additionally, the virtual content can track with the movements of the first user (e.g., user 106A) and the second user (e.g., user 106B).

FIGS. 3 and 4 above illustrate non-limiting examples of a user interface that can be presented on a display (e.g., display 204) of a mixed reality device (e.g., device 108A, device 108B, and/or device 108C) wherein the application can be associated with causing a virtual representation of a flame to appear in a position consistent with where the first user (e.g., user 106A) contacts the second user (e.g., user 106B).

As described above, in additional or alternative examples, an application can be associated with causing a graphical representation corresponding to a sticker, a tattoo, an accessory, etc. to be presented on the display 204. The sticker, tattoo, accessory, etc. can conform to the body representation of the second user (e.g., user 106B) receiving the graphical representation corresponding to the sticker, tattoo, accessory, etc. (e.g., from the first user 106A). Accordingly, the graphical representation can augment the second user (e.g., user 106B) in the mixed reality environment. The graphical representation corresponding to the sticker, tattoo, accessory, etc. can appear to be positioned on the second user (e.g., user 106B) in a position that corresponds to where the first user (e.g., user 106A) contacts the second user (e.g., user 106B).

In some examples, the graphical representation corresponding to a sticker, tattoo, accessory, etc. can be privately shared between the first user (e.g., user 106A) and the second user (e.g., user 106B) for a predetermined period of time. That is, the graphical representation corresponding to the sticker, the tattoo, or the accessory can be presented to the (e.g., user 106A) and the second user (e.g., user 106B) each time the first user (e.g., user 106A) and the second user (e.g., user 106B) are present at a same time in the mixed reality environment. The first user (e.g., user 106A) and/or the second user (e.g., user 106B) can indicate a predetermined period of time for presenting the graphical representation after which, neither the first user (e.g., user 106A) and/or the second user (e.g., user 106B) can see the graphical representation.

In some examples, an application can be associated with causing a virtual representation corresponding to a color change to be presented to indicate where the first user (e.g., user 106A) interacted with the second user (e.g., user 106B). In other examples, an application can be associated with causing a graphical representation of physiological data associated with the first user (e.g., user 106A) and/or the second user (e.g., user 106B) to be presented. As a non-limiting example, the second user (e.g., user 106B) can be able to see a graphical representation of the first user's (e.g., user 106A) heart rate, temperature, etc. In at least one example, a user's heart rate can be graphically represented by a pulsing aura associated with the first user (e.g., user 106A) and/or the user's skin temperature can be graphically represented by a color changing aura associated with the first user (e.g., user 106A). In some examples, the pulsing aura and/or color changing aura can correspond to a position associated with the interaction between the first user (e.g., 106A) and the second user (e.g., user 106B).

In at least one example, a user (e.g., user 106A, user 106B, and/or user 106C) can utilize an application to define a response to an interaction and/or the virtual content that can be presented based on the interaction. In a non-limiting example, a first user (e.g., user 106A) can indicate that he or she desires to interact with a second user (e.g., user 106B) such that the first user (e.g., user 106A) can use a virtual paintbrush to cause virtual content corresponding to paint to appear on the second user (e.g., user 106B) in a mixed reality environment.

In additional and/or alternative examples, the interaction between the first user (e.g., 106A) and the second user (e.g., user 106B) can be synced with haptic feedback. For instance, as a non-limiting example, when a first user (e.g., 106A) strokes a virtual representation of a second user (e.g., user 106B), the second user (e.g., user 106B) can experience a haptic sensation associated with the interaction (i.e., stroke) via a mixed reality device and/or a peripheral device associated with the mixed reality device.

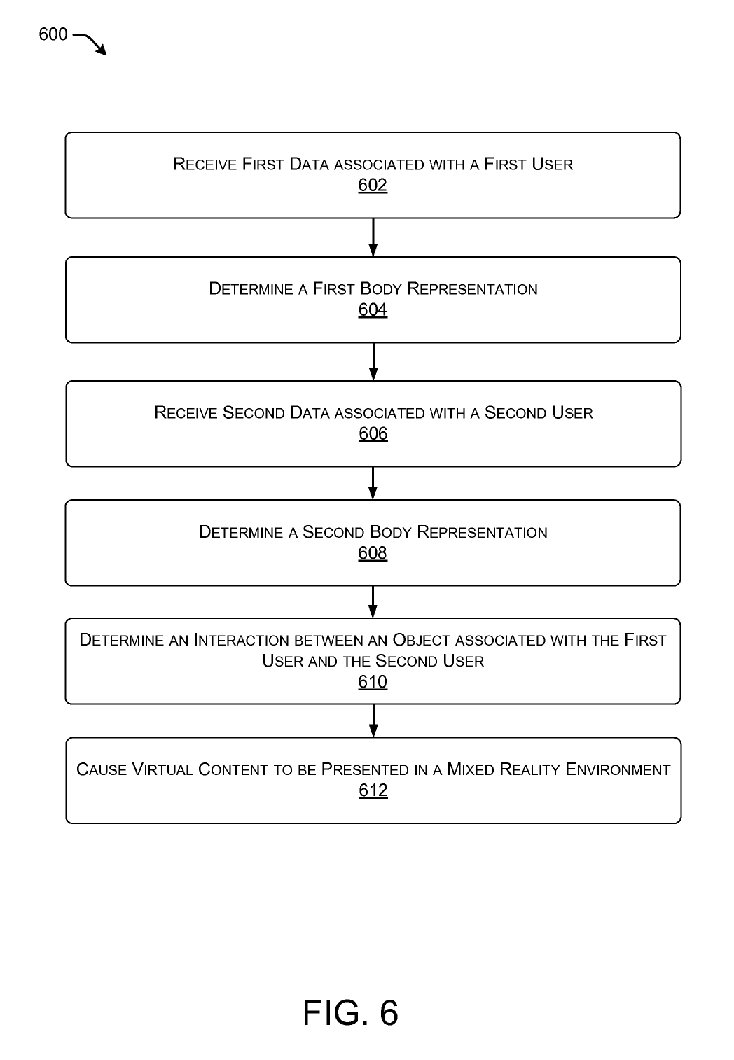

FIG. 6 is a flow diagram that illustrates an example process 600 to cause virtual content to be presented in a mixed reality environment via a mixed reality display device.

Block 602 illustrates receiving first data associated with a first user (e.g., user 106A). The first user (e.g., user 106A) can be physically present in a real scene of a mixed reality environment. As described above, in at least one example, the input module 116 is configured to receive streams of volumetric data associated with the first user (e.g., user 106A), skeletal data associated with the first user (e.g., user 106A), perspective data associated with the first user (e.g., user 106A), etc. in substantially real time.

Block 604 illustrates determining a first body representation. Combinations of the volumetric data associated with the first user (e.g., user 106A), the skeletal data associated with the first user (e.g., user 106A), and/or the perspective data associated with the first user (e.g., user 106A) can be used to determine a first body representation corresponding to the first user (e.g., user 106A). In at least one example, the input module 116 can segment the first body representation to generate a segmented first body representation. The segments can correspond to various portions of a user's (e.g., user 106A) body (e.g., hand, arm, foot, leg, head, etc.). Different pieces of virtual content can correspond to particular segments of the segmented first body representation.

Block 606 illustrates receiving second data associated with a second user (e.g., user 106B). The second user (e.g., user 106B) can be physically or virtually present in the real scene associated with a mixed reality environment. If the second user (e.g., user 106B) is not in a same real scene as the first user (e.g., user 106A), the device (e.g., device 108A) corresponding to the first user (e.g., user 106A) can receive streaming data to render the second user (e.g., user 106B) in the mixed reality environment. As described above, in at least one example, the input module 116 is configured to receive streams of volumetric data associated with the second user (e.g., user 106B), skeletal data associated with the second user (e.g., user 106B), perspective data associated with the second user (e.g., user 106B), etc. in substantially real time.

Block 608 illustrates determining a second body representation. Combinations of the volumetric data associated with a second user (e.g., user 106B), skeletal data associated with the second user (e.g., user 106B), and/or perspective data associated with the second user (e.g., user 106B) can be used to determine a body representation that represents the second user (e.g., user 106A). In at least one example, the input module 116 can segment the second body representation to generate a segmented second body representation. Different pieces of virtual content can correspond to particular segments of the segmented second body representation.

Block 610 illustrates determining an interaction between an object associated with the first user (e.g., user 106A) and the second user (e.g., user 106B). The interaction module 118 is configured to determine whether a first user (e.g., user 106A) and/or an object associated with the first user (e.g., user 106A) interacts with a second user (e.g., user 106B). In some examples, the object can be a body part associated with the first user (e.g., user 106A). In such examples, the interaction module 118 can determine that the first user (e.g., user 106A) interacts with the second user (e.g., user 106B) based at least in part on determining that the body representation corresponding to the first user (e.g., user 106A) is within a threshold distance of a body representation corresponding to the second user (e.g., user 106B). In other examples, the object can be an extension of the first user (e.g., user 106A), as described above. The extension can include a real object or a virtual object associated with at least one of the first user (e.g., user 106A) or the second user (e.g., user 106B). In yet other examples, the first user (e.g., user 106A) can cause an interaction with a second user (e.g., user 106B), as described above.

Block 612 illustrates causing virtual content to be presented in a mixed reality environment. The presentation module 120 is configured to send rendering data to devices 108 for presenting virtual content via the devices. Based at least in part on determining that the first user (e.g., user 106A) interacts with the second user (e.g., user 106B), the presentation module 120 can access data associated with instructions for rendering virtual content that is associated with at least one of the first user (e.g., user 106A) or the second user (e.g., user 106B) in the mixed reality environment. The instructions can be determined by the one or more applications 128 and/or 132, as described above. In at least one example, the presentation module 120 can access data stored in the permissions module 122 to determine whether the interaction is permitted. The rendering module(s) 130 associated with a first device (e.g., device 108A) and/or a second device (e.g., device 108B) can receive rendering data from the service provider 102 and can utilize one or more rendering algorithms to render virtual content on the display 204 of the first device (e.g., device 108A) and/or a second device (e.g., device 108B). The virtual content can conform to the body representations associated with the first user (e.g., user 106A) and/or the second user (e.g., user 106B) so as to augment the first user (e.g., user 106A) and/or the second user (e.g., user 106B). Additionally, the virtual content can track with the movements of the first user (e.g., user 106A) and the second user (e.g., user 106B).

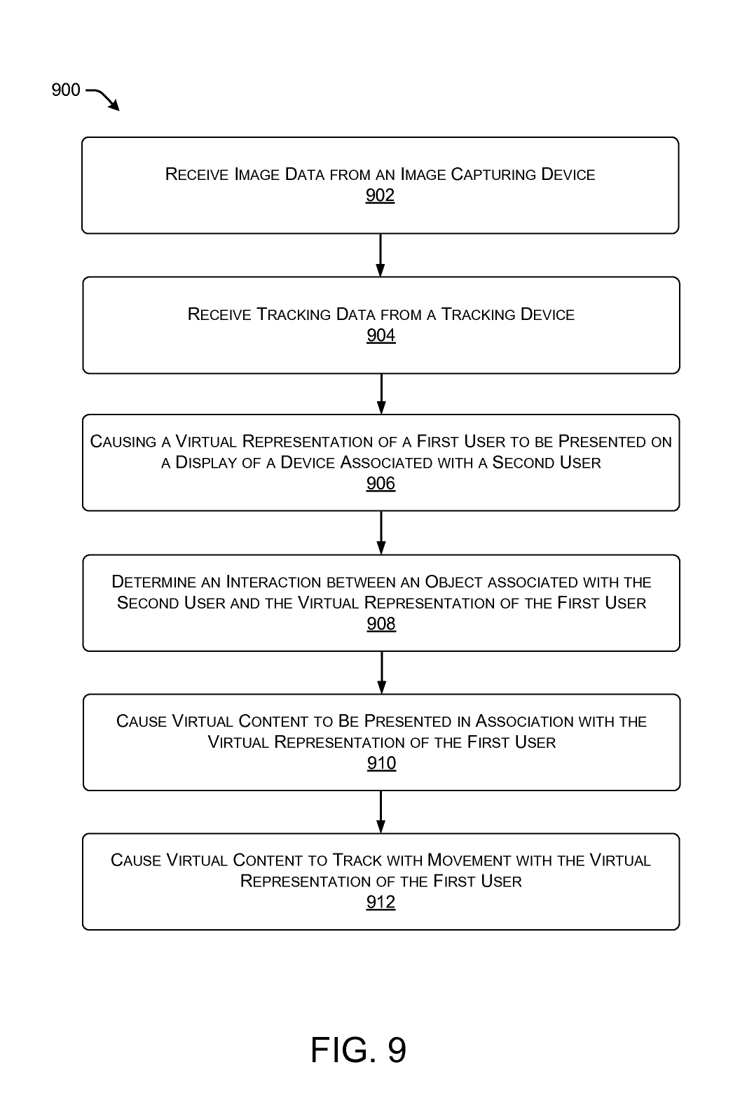

FIG. 9 is a flow diagram that illustrates an example process 900 to cause virtual content to be presented in a remote communication environment via a display device (e.g., device 108A, device 108B, and/or device 108C).

Block 902 illustrates receiving image data from an image capturing device (e.g., sensor 202). In at least one example, the image capturing device can start capturing image data based at least in part on determining an initiation of a communication (e.g., an online video communication, an online conference communication, an online screen sharing communication, etc.) between a first device (e.g., device 108A) and one or more other devices (e.g., device 108B, device 108C. etc.). The image capturing device can continue to capture image data over a period of time, such as the duration of the communication. In some examples, the image capturing devices can be associated with devices 108 and can capture and stream image data directly from a first device (e.g., device 108A) to one or more other devices (e.g., device 108B, device 108C, etc.). In other examples, the image data can be received by the input module 116 from a first device (e.g., device 108A) and sent to the rendering module 130 associated with one or more other devices (e.g., device 108B, device 108C, etc.) for rendering image content on the display 204. In such examples, the image content can depict the real scene in which the respective user (e.g., user 106A, user 106B, user 106C, etc.) is physically located, including the virtual representation of the respective user (e.g., user 106A, user 106B, user 106C, etc.).

Block 904 illustrates receiving tracking data from a tracking device (e.g., sensor 202). As described above, in at least one example, the input module 116 is configured to receive data associated with positions and orientations of users 106 and their bodies in space (e.g., tracking data). In at least one example, the tracking device can start tracking a user (e.g., user 106A, user 106B, user 106C, etc.) based at least in part on determining an initiation of a communication (e.g., an online video communication, an online conference communication, an online screen sharing communication, etc.) between a first device (e.g., device 108A) and one or more other devices (e.g., device 108B, device 108C. etc.). The image capturing device can continue to capture image data over a period of time, such as the duration of the communication. In some examples described above, tracking devices can output streams of volumetric data, skeletal data, perspective data, etc. (e.g., three-dimensional tracking data) in substantially real time. In additional and/or alternative examples, the input module 116 can receive motion capture data (e.g., two-dimensional tracking data) that tracks the motion of objects, users (e.g., user 106A, user 106B, and/or user 106C), etc. in substantially real time. In some examples, the tracking devices can be associated with devices 108 and stream tracking data directly from a first device (e.g., device 108A) to one or more other devices (e.g., device 108B, device 108C, etc.). In other examples, the tracking data can be received by the input module 116 from a first device (e.g., device 108A) and sent to the rendering module 130 associated with one or more other devices (e.g., device 108B, device 108C, etc.).

Block 906 illustrates causing a virtual representation of a first user (e.g., user 106A) to be presented on a display 204 of a device (e.g., device 108B) associated with a second user (e.g., user 106B). A first device (e.g., device 108A) associated with the first user (e.g., user 106A) can capture image data and stream the image data to a rendering module 130. In some cases, the image data can be sent to the input module 116 from the first device (e.g., device 108A) and the input module 116 can send the image data to the rendering module 130. The rendering module 130 associated with a second device (e.g., device 108B) associated with the second user (e.g., user 106B) can receive the image data and can render the virtual representation of the first user (e.g., user 106A) on a display 204 of the second device (e.g., device 108B). Additionally and/or alternatively, in some examples, the rendering module 130 associated with the first device (e.g., device 108A) can leverage the image data captured from the image capture device associated with the first device (e.g., device 108A) to render a virtual representation of the first user (e.g., user 106A) on the display 204 of the first device (e.g., device 108A). For instance, the first device (e.g., device 108A) corresponding to the first user (e.g., user 106A) can render a virtual representation of the first user (e.g., user 106A) in a picture-in-picture display, a split screen display, etc. In some examples, virtual representations of more than two users 106 can be rendered on individual displays 204 of the devices 108, for instance, in communications involving more than two users 106.

Block 908 illustrates determining an interaction between an object associated with the second user (e.g., user 106B) and the virtual representation of the first user (e.g., user 106A). The interaction module 118 is configured to determine that an object associated with a second user (e.g., user 106B) interacts with a virtual representation of a first user (e.g., user 106A). In some examples, the object can be a body part of the second user (e.g., user 106B). In such examples, the display 204 associated with the second device (e.g., device 108B) can be a touchscreen display and the interaction module 118 can determine that the body part of the second user (e.g., user 106B) interacts with a portion of the touchscreen display that corresponds to the virtual representation of the first user (e.g., user 106A). In other examples, the object can be an input peripheral device controlled by the second user (e.g., user 106B). As described herein, input peripheral devices can include a mouse, a pen, a game controller, a voice input device, a touch input device, gestural input device, etc. In such examples, the display of the second device (e.g., device 108B) can be a touchscreen display 204 or a conventional display 204.

In at least one example, the interaction module 118 can determine a position on the virtual representation of the first user (e.g., user 106A) where the object associated with the second user (e.g., user 106B) interacts with the virtual representation of the first user (e.g., user 106A). Additionally and/or alternatively, the interaction module 118 can determine a path of touch on the virtual representation of the first user (e.g., user 106A) where the object associated with the second user (e.g., user 106B) interacts with the virtual representation of the first user (e.g., user 106A) without interruption during the interaction. For instance, in an example where the display 204 associated with the second device (e.g., device 108B) is a touchscreen display, a second user (e.g., user 106B) can use his or her finger to stroke the virtual forearm of the virtual representation of the first user (e.g., user 106A), initiating a touch near the virtual elbow of the virtual representation of the first user (e.g., user 106A) and continuing the touch to the virtual wrist of the virtual representation of the first user (e.g., user 106A) without lifting his or her finger.

Block 910 illustrates causing virtual content to be presented in association with the virtual representation of the first user (e.g., user 106A). The presentation module 120 is configured to send rendering data to devices 108 for presenting virtual content via the devices 108. Based at least in part on determining an interaction between an object associated with the second user (e.g., user 106B) and the virtual representation of the first user (e.g., user 106A), the presentation module 120 can access data associated with instructions for rendering virtual content that is associated with at least one of the virtual representation of the first user (e.g., user 106A) or a virtual representation of the second user (e.g., user 106B) in the remote communication environment. The instructions can be determined by the one or more applications 124 and/or 132. In at least one example, as described above in the mixed reality context, the virtual content corresponding to the interaction can be defined by the second user (e.g., user 108B). That is, in a non-limiting example, the second user (e.g., user 108B) can define the virtual content corresponding to the interaction to be a virtual BAND-AID® 806 or a virtual heart 702, as illustrated in FIGS. 7A, 7B, 8A, and 8B, above.

The rendering module(s) 130 associated with a first device (e.g., device 108A) and/or a second device (e.g., device 108B) can receive rendering data from the presentation module 120 and can utilize one or more rendering algorithms to render virtual content on respective displays 204 of the first device (e.g., device 108A) and/or a second device (e.g., device 108B). That is, in some examples, based at least in part on determining the interaction, the presentation module 120 can send data to the rendering module 130 of each device (e.g., device 108A, device 108B, etc.) corresponding to a user (e.g., user 106A, user 106B, user 106C, etc.) authorized to view the virtual content, as described below. Each rendering module 130 can render the virtual content in the display 204 corresponding to the device (e.g., device 108A, device 108B, etc.) so that the first user (e.g., user 106A) can view the virtual content on the virtual representation of himself or herself and/or the second user (e.g., user 106B) and/or other users (e.g., user 106C, etc.) can view the virtual content on the virtual representation of the first user (e.g., user 106A) on a display 204 of a corresponding device (e.g., device 108A, device 108C, etc.).

The virtual content can conform to the virtual representations associated with the first user (e.g., user 106A) so as to augment the first user (e.g., user 106A) when presented on individual displays 204 of devices 108. The virtual content can be positioned on the virtual representation of the first user (e.g., user 106A) such to visually indicate a position on the virtual representation of the first user (e.g., user 106A) where the interaction occurred. Additionally, the virtual content can track with the movements of the first user (e.g., user 106A) based at least in part on the tracking data. For instance, the virtual content can persist in the position on the virtual representation of the first user (e.g., user 106A) such that when the first user (e.g., user 106A) moves, the virtual content persists in a same position relative to the virtual representation of the first user (e.g., user 106A) and appears to move with the first user (e.g., user 106A). Block 912 illustrates causing a virtual object to track with movement of the virtual representation of the first user (e.g., user 106A). That is, the rendering module 130 can access the tracking data and render the virtual content on a same position relative to the virtual representation of the first user (e.g., user 106A).

FIGS. 7A, 7B, 8A, and 8B, above, illustrate non-limiting examples of a user interface that can be presented on a display 204 of a device (e.g., device 108A, device 108B, and/or device 108C) wherein the application (e.g., application(s) 124 and/or 132) can be associated with causing virtual content (e.g., the virtual heart 702, the virtual BAND-AID® 806) to appear in a position consistent with where the interaction between an object associated with the second user (e.g., user 106B) and the virtual representation of the first user (e.g., user 106A) occurred. Additional and/or alternative examples are described herein.

In at least one example, an interaction between an object associated with a second user (e.g., user 106B) and a virtual representation of a first user (e.g., user 106A) can cause virtual content to be displayed on both the virtual representation of the first user (e.g., user 106A) and the virtual representation of the second user (e.g., user 106B). The virtual content can conform to the virtual representations associated with the first user (e.g., user 106A) and the second user (e.g., user 106B) so as to augment the first user (e.g., user 106A) and the second user (e.g., user 106B) on individual displays 204 of corresponding devices (e.g., device 108A, device 108B, etc.). The virtual content can be positioned on the virtual representations associated with the first user (e.g., user 106A) and the second user (e.g., user 106B) such to visually indicate a position on each virtual representation where the interaction occurred. Additionally, the virtual content can track with the movements of the first user (e.g., user 106A) and the second user (e.g., user 106B).

For instance, as described above in the context of mixed reality, an interaction between an object associated with a second user (e.g., user 106B) and a virtual representation of a first user (e.g., user 106A) can cause a virtual flame to be presented such to augment both the virtual representation of the first user (e.g., user 106A) and the virtual representation of the second user (e.g., user 106B). The virtual flame can be positioned on the virtual representations associated with the first user (e.g., user 106A) and the second user (e.g., user 106B) such to visually indicate a position on each virtual representation where the interaction occurred. For instance, if the second user (e.g., user 106B) used the tip of his or her finger to touch a virtual elbow of the virtual representation of the first user (e.g., user 106A), a first virtual flame can be positioned on the tip of the second user's (e.g., user 106B) finger and a second virtual flame can be positioned on the virtual elbow of the virtual representation of the first user (e.g., user 106A). The first flame can track with the movement of the second user (e.g., user 106B) and the second flame can track with the movement of the first user (e.g., user 106A).

As described above, data associated with the virtual content, data associated with position and/or orientation of the virtual content, data associated with a predetermined amount of time virtual content persists (e.g., expiration data), etc. can be mapped to unique identifiers associated with the first user (e.g., user 106A) and/or the second user (e.g., user 106B) and can be stored in the database 125. As a result, each time the identification module 117 identifies that the first user (e.g., user 106A) and/or the second user (e.g., user 106B) initiate a communication involving at least the first user (e.g., user 106A) and/or the second user (e.g., user 106B), the presentation module 120 can access the database 125 to determine whether any virtual content is mapped to the unique identifiers corresponding to the first user (e.g., user 106A) and/or the second user (e.g., user 106B), and can send data associated with the virtual content mapped to the unique identifiers to the rendering module 130 on each corresponding device (e.g., device 108A and/or device 108B). In some examples, the virtual content can persist beyond a single communication. For instance, the virtual content can persist until the virtual content expires or is removed by either the first user (e.g., user 106A) or the second user (e.g., user 106B), as described below.

In a non-limiting example, the service provider 102 can determine that a first communication wherein the virtual content is presented on display(s) 204 corresponding to the first device (e.g., device 108A) and/or the second device (e.g., device 108B) is terminated. Subsequently, the service provider 102, via the identification module 117, can determine that a second communication between the first device (e.g., device 108A) and the second device (e.g., device 108B) is initiated. The presentation module 120 can determine that the virtual content is mapped to at least one of the unique identifiers corresponding to the first user (e.g., user 106A) and/or the second user (e.g., user 106B). The presentation module 120 can determine whether the virtual content is not expired based at least in part on data associated with the virtual content. Based at least in part on determining that the virtual content is not expired, the presentation module 120 can send data corresponding to the virtual content to the respective rendering modules 130 for rendering the virtual content on the first device (e.g., device 108A) and/or the second device (e.g., device 108B). The rendering modules 130 can render the virtual content in a same position and/or orientation relative to the virtual representation of the first user (e.g., user 106A) as the virtual content was in when the immediately preceding communication was terminated.

In at least one example, the presentation module 120 can access data (e.g., permissions data) stored in the permissions module 122 and/or the database 125 to determine whether the interaction is permitted and/or to identify which users 106 in a remote communication environment are authorized to view the virtual content. As described above, individual users (e.g., user 106A, user 106B, user 106C, etc.) can be associated with unique identifiers. Permissions data mapped to the unique identifiers can indicate interactions that are permitted between particular users 106, which users 106 are authorized to view virtual content mapped to the unique identifiers, which users 106 are authorized to remove virtual content (e.g., terminate virtual content from being presented on a display 204), etc.

In some examples, a user (e.g., user 106A) can determine which other users (e.g., user 106B and/or user 106C) are authorized to engage in particular interactions with the user (e.g., user 106A). For instance, a first user (e.g., user 106A) can authorize a second user (e.g., user 106B) to participate in intimate interactions but can prohibit a third user (e.g., user 106C) from participating in the same interactions. If a user (e.g., user 106C) is not authorized to interact with another user (e.g., user 106A) virtual content corresponding to the interaction is not presented on the display 204 of devices (e.g., device 108A or device 108C) corresponding to the users (e.g., user 106A and user 106C). Additionally and/or alternatively, permissions data can determine which users 106 are authorized to view virtual content resulting from an interaction between users 106. For instance, multiple users (e.g., user 106A, user 106B, user 106C, etc.) can participate in a communication and a first user (e.g., user 106A) may want to interact with a second user (e.g., user 106B) in a way that a third user (e.g., user 106C) cannot see on his or her display 204. That is, in some examples, the virtual content can be privately shared between the first user (e.g., user 106A) and the second user (e.g., user 106B). As mentioned above, that virtual content can be privately shared such that the virtual content can be presented to the first user (e.g., user 106A) and the second user (e.g., user 106B) each time the first user (e.g., user 106A) and the second user (e.g., user 106B) are communicating via the remote communication environment, until the virtual content is either removed or expires.

As described above, virtual content can be associated with expiration data. Expiration data can indicate a predetermined period of time for presenting the virtual content after which, neither the first user (e.g., user 106A) and/or the second user (e.g., user 106B) can see the virtual content. Virtual content that expires can terminate the mapping between the virtual content and the unique identifiers. Additionally and/or alternatively, permissions data can indicate users 106 that are authorized to remove virtual content, thereby terminating the virtual content from being presented on the display(s) 204. Removing virtual content can terminate the mapping between the virtual content and the unique identifiers. In a non-limiting example, a first user (e.g., user 106A) can cause a virtual BAND-AID® 806 to be presented on the virtual representation of the second user (e.g., user 106B), as illustrated in FIG. 8B. The virtual BAND-AID® 806 can persist until an authorized user (e.g., user 106A and/or user 106B) removes the virtual BAND-AID® 106 or the virtual BAND-AID® 106 expires based on a lapse of a predetermined period of time.

As described above, in additional or alternative examples, an application (e.g., application(s) 124 and/or 132) can be associated with causing virtual content corresponding to a color change to be presented to indicate where the second user (e.g., user 106B) interacted with the virtual representation of the first user (e.g., user 106A). For instance, if the object associated with the second user (e.g., user 106B) interacts with the virtual representation of the first user (e.g., user 106A) such to touch the virtual representation of the first user (e.g., user 106A) from the virtual shoulder to the virtual wrist, virtual content can be rendered such to cause a color change of the virtual representation of the first user (e.g., user 106a) from the virtual shoulder of the virtual representation of the first user (e.g., user 106A) to the virtual wrist (e.g., along the path of touch). The virtual content that causes the color change can track with the movement of the first user (e.g., user 106A).

In other examples, an application (e.g., application(s) 124 and/or 132) can be associated with therapeutic applications for treating chronic pain and movement disorders by causing changes to the way a virtual representation corresponding to a user (e.g., user 106A, user 106B, user 106C) behaves. For instance, a first user (e.g., user 106A) may be unable to move his or her injured limb. A second user (e.g., user 106B) can be a remotely located physical therapist that can guide the first user's (e.g., user 106A) movement via interactions with a virtual representation of the first user (e.g., user 106A) in the remote communication environment. For instance, if the first user (e.g., user 106A) is not sufficiently flexing his or her hand, the second user (e.g., user 106B) can interact with the virtual representation corresponding to the first user's (e.g., user 106A) hand such to guide the first user (e.g., user 106A) in flexing. As an example, the second user (e.g., user 106B) can draw with virtual content on the virtual representation corresponding to the first user's (e.g., user 106A) hand to show the first user (e.g., user 106A) how to flex.

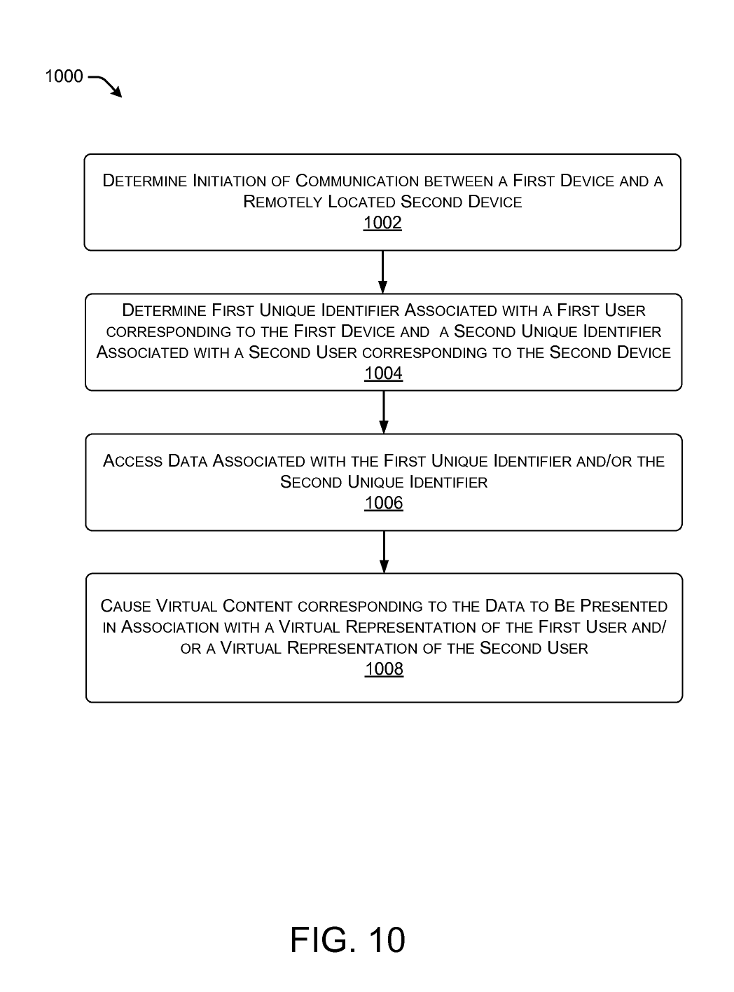

FIG. 10 is a flow diagram that illustrates an example process 1000 to cause virtual content to be presented in a remote communication environment via a display device (e.g., device 108A, device 108B, and/or device 108C).

Block 1002 illustrates determining the initiation of a communication between a first device (e.g., device 108A) corresponding to a first user (e.g., user 106A) and a second device (e.g., device 108B) corresponding to a second user (e.g., user 106B). The first device (e.g., device 108A) and the second device (e.g., device 108B) can be remotely located (i.e., physically located in different physical locations). The first user (e.g., user 106A) and/or the second user (e.g., user 106B) can initiate a communication via a remote communication service provider using an application (e.g., application(s) 132) on his or her device (e.g., device 108A or device 108B, respectively), a website, etc.

Block 1004 illustrates determining a first unique identifier associated with the first user (e.g., user 106A) and the second unique identifier associated with the second user (e.g., user 106B). Based at least in part on determining the initiation of the communication between the first user (e.g., user 106A) and the second user (e.g., user 106B), the identification module 117 can determine the first unique identifier associated with the first user (e.g., user 106A) and the second unique identifier associated with the second user (e.g., user 106B). As described above, unique identifiers can be phone numbers, user names, etc.

Block 1006 illustrates accessing data associated with the first unique identifier and the second unique identifier. Each of the unique identifiers can be mapped to different data, including, but not limited to, data associated with virtual content that is associated with a user (e.g., user 106A, user 106B, or user 106C) corresponding to the unique identifier, data associated with position and/or orientation of the virtual content, data associated with a predetermined amount of time that the virtual content persists (e.g., expiration data), etc. Additionally and/or alternatively, data associated with permissions (e.g., permissions data), that can be stored in the permissions module 122, can be mapped to the unique identifier.

Block 1008 illustrates causing virtual content corresponding to the data to be presented in association with the virtual representation of the first user (e.g., user 106A) and/or the virtual representation of the second user (e.g., user 106B). The presentation module 120 is configured to send rendering data to rendering modules 130 on devices 108 for presenting virtual content via displays 204 on the devices 108. Based at least in part on accessing data associated with the first unique identifier and/or the second unique identifier, the presentation module 120 can access data associated with instructions for rendering virtual content that is associated with at least one of the first user (e.g., user 106A) or the second user (e.g., user 106B) in the remote communication environment. The instructions can be determined by the one or more applications 124 and/or 132. In at least one example, the presentation module 120 can access data stored in the permissions module 122 and/or the database 125 to determine whether the interaction is permitted. The rendering modules 130 associated with a first device (e.g., device 108A) and/or a second device (e.g., device 108B) can receive rendering data from the presentation module 120 and can utilize one or more rendering algorithms to render virtual content on the display 204 of the first device (e.g., device 108A) and/or a second device (e.g., device 108B), as described above.

### Example Clauses

A. A system comprising a sensor; one or more processors; memory; and one or more modules stored in the memory and executable by the one or more processors to perform operations comprising: receiving data from the sensor; determining, based at least in part on receiving the data, that an object associated with a first user that is physically present in a real scene interacts with a second user that is present in the real scene via an interaction; and based at least in part on determining that the object interacts with the second user, causing virtual content corresponding to the interaction and at least one of the first user or the second user to be presented on a user interface corresponding to a mixed reality device associated with the first user, wherein the user interface presents a view of the real scene as viewed by the first user that is enhanced with the virtual content.

B. The system as paragraph A recites, wherein the second user is physically present in the real scene.

C. The system as paragraph A recites, wherein the second user is physically present in a different real scene than the real scene; and the operations further comprise causing the second user to be virtually present in the real scene by causing a graphic representation of the second user to be presented via the user interface.

D. The system as any of paragraphs A-C recite, wherein the object comprises a virtual object associated with the first use.

E. The system as any of paragraphs A-C recite, wherein the object comprises a body part of the first user.

F. The system as paragraph E recites, wherein receiving the data comprises receiving, from the sensor, at least one of first volumetric data or first skeletal data associated with the first user; and receiving, from the sensor, at least one of second volumetric data or second skeletal data associated with the second user; and the operations further comprise: determining a first body representation associated with the first user based at least in part on the at least one of the first volumetric data or the first skeletal data; determining a second body representation associated with the second user, based at least in part on the at least one of the second volumetric data or the second skeletal data; and determining that the body part of the first user interacts with the second user based at least in part on determining that the first body representation is within a threshold distance of the second body representation.

G. The system as any of paragraphs A-F recite, wherein the virtual content corresponding to the interaction is defined by the first user.

H. The system as any of paragraphs A-G recite, wherein the sensor comprises an inside-out sensing sensor.

I. The system as any of paragraphs A-G recite, wherein the sensor comprises an outside-in sensing sensor.

J. A method for causing virtual content to be presented in a mixed reality environment, the method comprising: receiving, from a sensor, first data associated with a first user that is physically present in a real scene of the mixed reality environment; determining, based at least in part on the first data, a first body representation that corresponds to the first user; receiving, from the sensor, second data associated with a second user that is present in the real scene of the mixed reality environment; determining, based at least in part on the second data, a second body representation that corresponds to the second user; determining, based at least in part on the first data and the second data, an interaction between the first user and the second user; and based at least in part on determining the interaction, causing virtual content to be presented in association with at least one of the first body representation or the second body representation on at least one of a first display associated with the first user or on a second display associated with the second user.

K. A method paragraph J recites, further comprising receiving streaming data for causing the second user to be virtually present in the real scene of the mixed reality environment.

L. A method as either paragraph J or K recites, wherein: the first data comprises at least one of volumetric data associated with the first user, skeletal data associated with the first user, or perspective data associated with the first user; and the second data comprises at least one of volumetric data associated with the second user, skeletal data associated with the second user, or perspective data associated with the second user.

M. A method any of paragraphs J-L recite, wherein the virtual content comprises a graphical representation of physiological data associated with at least the first user or the second user.

N. A method any of paragraphs J-M recite, wherein the virtual content comprises a graphical representation corresponding to a sticker, a tattoo, or an accessory that conforms to at least the first body representation or the second body representation at a position on at least the first body representation or the second body representation corresponding to the interaction.

O. A method as paragraph N recites, further comprising causing the graphical representation corresponding to the sticker, the tattoo, or the accessory to be presented to the first user and the second user each time the first user and the second user are present at a same time in the mixed reality environment.

P. A method as any of paragraphs J-O recite, further comprising: determining permissions associated with at least one of the first user or the second user; and causing the virtual content to be presented in association with at least one of the first body representation or the second body representation based at least in part on the permissions.

Q. One or more computer-readable media encoded with instructions that, when executed by a processor, configure a computer to perform a method as any of paragraphs J-P recite.

R. A device comprising one or more processors and one or more computer readable media encoded with instructions that, when executed by the one or more processors, configure a computer to perform a computer-implemented method as recited in any of paragraphs J-P.

S. A method for causing virtual content to be presented in a mixed reality environment, the method comprising: means for receiving, from a sensor, first data associated with a first user that is physically present in a real scene of the mixed reality environment; means for determining, based at least in part on the first data, a first body representation that corresponds to the first user; means for receiving, from the sensor, second data associated with a second user that is present in the real scene of the mixed reality environment; means for determining, based at least in part on the second data, a second body representation that corresponds to the second user; means for determining, based at least in part on the first data and the second data, an interaction between the first user and the second user; and based at least in part on determining the interaction, means for causing virtual content to be presented in association with at least one of the first body representation or the second body representation on at least one of a first display associated with the first user or on a second display associated with the second user.

T. A method paragraph S recites, further comprising means for receiving streaming data for causing the second user to be virtually present in the real scene of the mixed reality environment.

U. A method as either paragraph S or T recites, wherein: the first data comprises at least one of volumetric data associated with the first user, skeletal data associated with the first user, or perspective data associated with the first user; and the second data comprises at least one of volumetric data associated with the second user, skeletal data associated with the second user, or perspective data associated with the second user.

V. A method any of paragraphs S-U recite, wherein the virtual content comprises a graphical representation of physiological data associated with at least the first user or the second user.

W. A method any of paragraphs S-V recite, wherein the virtual content comprises a graphical representation corresponding to a sticker, a tattoo, or an accessory that conforms to at least the first body representation or the second body representation at a position on at least the first body representation or the second body representation corresponding to the interaction.

X. A method as paragraph W recites, further comprising means for causing the graphical representation corresponding to the sticker, the tattoo, or the accessory to be presented to the first user and the second user each time the first user and the second user are present at a same time in the mixed reality environment.

Y. A method as any of paragraphs S-X recite, further comprising: means for determining permissions associated with at least one of the first user or the second user; and means for causing the virtual content to be presented in association with at least one of the first body representation or the second body representation based at least in part on the permissions.

Z. A device configured to communicate with at least a first mixed reality device and a second mixed reality device in a mixed reality environment, the device comprising: one or more processors; memory; and one or more modules stored in the memory and executable by the one or more processors to perform operations comprising: receiving, from a sensor communicatively coupled to the device, first data associated with a first user that is physically present in a real scene of the mixed reality environment; determining, based at least in part on the first data, a first body representation that corresponds to the first user; receiving, from the sensor, second data associated with a second user that is physically present in the real scene of the mixed reality environment; determining, based at least in part on the second data, a second body representation that corresponds to the second user; determining, based at least in part on the first data and the second data, that the second user causes contact with the first user; and based at least in part on determining that the second user causes contact with the first user, causing virtual content to be presented in association with the first body representation on a first display associated with the first mixed reality device and a second display associated with the second mixed reality device, wherein the first mixed reality device corresponds to the first user and the second mixed reality device corresponds to the second user.

AA. A device as paragraph Z recites, the operations further comprising: determining, based at least in part on the first data, at least one of a volume outline or a skeleton that corresponds to the first body representation; and causing the virtual content to be presented so that it conforms to the at least one of the volume outline or the skeleton.

AB. A device as either paragraph Z or AA recites, the operations further comprising: segmenting the first body representation to generate a segmented first body representation; and causing the virtual content to be presented on a segment of the segmented first body representation corresponding to a position on the first user where the second user causes contact with the first user.

AC. A device as any of paragraphs Z-AB recite, the operations further comprising causing the virtual content to be presented to visually indicate a position on the first user where the second user causes contact with the first user.

AD. A system comprising: one or more processors; memory; and one or more modules stored in the memory and executable by the one or more processors to perform operations comprising: determining initiation of a communication between a first device associated with a first user and a second device associated with a second user, the second device being remotely located from the first device; receiving, from an image capturing device associated with the first device, image data associated with the first user; receiving, from a tracking device associated with the first device, tracking data associated with the first user; causing, based at least in part on the image data, a virtual representation of the first user to be presented on a first display corresponding to the second device; determining an interaction between an object associated with the second user and the virtual representation of the first user; causing virtual content to be presented on at least the first display corresponding to the second device in a position on the virtual representation of the first user corresponding to the interaction; and causing, based at least in part on the tracking data, the virtual content to track with movement of the first user.

AE. The system as paragraph AD recites, wherein: the first display comprises a touchscreen display; and the interaction is between the object and a portion of the touchscreen display corresponding to the virtual representation.

AF. The system as paragraph AE recites, wherein the object comprises a body part of the second user.

AG. The system as any of paragraphs AD-AF recite, wherein the object comprises an input peripheral device controlled by the second user.

AH. The system as any of paragraphs AD-AG recite, the operations further comprising, based at least in part on the interaction, causing the virtual content to be presented on a second display associated with the first device in the position on the virtual representation of the first user.

AI. The system as any of paragraphs AD-AH recite, the operations further comprising determining a first unique identifier associated with the first user and second unique identifier associated with the second user.

AJ. The system as paragraph AI recites, the operations further comprising mapping the virtual content to at least one of the first unique identifier or the second unique identifier.

AK. The system as paragraph AI recites, wherein permissions data associated with at least one of the first unique identifier or the second unique identifier indicates authorizations associated with at least one of the first user or the second user for terminating the virtual content from being presented on at least the first display.

AL. The system as any of paragraphs AD-AK recite, the operations further comprising terminating the virtual content from being presented on at least the first display based at least in part on expiration data associated with the virtual content.

AM. A method for causing virtual content to be presented in a remote communication environment, the method comprising: receiving, from an image capturing device associated with a first device, image data associated with a first user corresponding to the first device; causing, based at least in part on the image data, a virtual representation of the first user to be presented on a second device corresponding to a second user; determining an interaction between an object associated with the second user and the virtual representation of the first user; and based at least in part on the interaction, causing virtual content to be presented on the virtual representation of the first user on a first display of the first device and a second display of the second device.

AN. The method as paragraph AM recites, wherein causing the virtual content to be presented on the virtual representation of the first user comprises causing the virtual content to be rendered in a position on the virtual representation of the first user corresponding to the interaction.

AO. The method as paragraph AN recites, further comprising: receiving, from a tracking device associated with the first device, tracking data associated with the first user; and causing, based at least in part on the tracking data, the virtual content to persist in the position on the virtual representation of the first user such to track with movement of the first user.

AP. The method as paragraph AO recites, wherein the image data and the tracking data are received over a period of time.

AQ. The method as any of paragraphs AM-AP recite, further comprising prior to causing the virtual content to be presented on the virtual representation of the first user on the first display and the second display, accessing first permissions data associated with the first user and second permissions data associated with the second user.

AR. The method as paragraph AQ recites, further comprising, based at least in part on accessing the first permissions data and the second permissions data, determining that the interaction is authorized between the first user and the second user.

AS. The method as paragraph AQ recites, further comprising: determining that the remote communication environment includes the first user, the second user, and a third user; accessing third permissions data associated with the third user; and determining, based at least in part on at least one of the first permissions data, the second permissions data, or the third permissions data, that the third user is not authorized to view the virtual content.

AT. The method as paragraph AQ recites, further comprising: terminating a first communication associated with causing the virtual content to be presented on the virtual representation of the first user on the first display and the second display; determining initiation of a new communication between the first user device and the second user device; determining that the virtual content is mapped to the first unique identifier and the second unique identifier; determining that the virtual content has yet to expire; and causing the virtual content to be presented on the virtual representation of the first user on the first display and the second display for at least a portion of the new communication.

AU. One or more computer-readable media encoded with instructions that, when executed by a processor, configure a computer to perform a method as any of paragraphs AM-AT recite.

AV. A device comprising one or more processors and one or more computer readable media encoded with instructions that, when executed by the one or more processors, configure a computer to perform a computer-implemented method as any of paragraphs AM-AT recite.

AW. A method for causing virtual content to be presented in a remote communication environment, the method comprising: means for receiving, from an image capturing device associated with a first device, image data associated with a first user corresponding to the first device; means for causing, based at least in part on the image data, a virtual representation of the first user to be presented on a second device corresponding to a second user; means for determining an interaction between an object associated with the second user and the virtual representation of the first user; and means for, based at least in part on the interaction, causing virtual content to be presented on the virtual representation of the first user on a first display of the first device and a second display of the second device.

AX. The method as paragraph AW recites, wherein causing the virtual content to be presented on the virtual representation of the first user comprises causing the virtual content to be rendered in a position on the virtual representation of the first user corresponding to the interaction.

AY. The method as paragraph AX recites, further comprising: means for receiving, from a tracking device associated with the first device, tracking data associated with the first user; and means for causing, based at least in part on the tracking data, the virtual content to persist in the position on the virtual representation of the first user such to track with movement of the first user.

AZ. The method as paragraph AY recites, wherein the image data and the tracking data are received over a period of time.

BA. The method as any of paragraphs AW-AZ recite, further comprising means for, prior to causing the virtual content to be presented on the virtual representation of the first user on the first display and the second display, accessing first permissions data associated with the first user and second permissions data associated with the second user.

BB. The method as paragraph BA recites, further comprising, means for, based at least in part on accessing the first permissions data and the second permissions data, determining that the interaction is authorized between the first user and the second user.

BC. The method as paragraph BA recites, further comprising: means for, determining that the remote communication environment includes the first user, the second user, and a third user; means for accessing third permissions data associated with the third user; and means for determining, based at least in part on at least one of the first permissions data, the second permissions data, or the third permissions data, that the third user is not authorized to view the virtual content.

BD. The method as paragraph BA recites, further comprising: means for terminating a first communication associated with causing the virtual content to be presented on the virtual representation of the first user on the first display and the second display; means for determining initiation of a new communication between the first user device and the second user device; means for determining that the virtual content is mapped to the first unique identifier and the second unique identifier; determining that the virtual content has yet to expire; and means for causing the virtual content to be presented on the virtual representation of the first user on the first display and the second display for at least a portion of the new communication.

BE. One or more computer storage media having computer-executable instructions that, when executed by one or more processors, configure the one or more processors to perform operations comprising: receiving, from an image capturing device associated with a first device, image data associated with a first user corresponding to the first device; receiving, from a tracking device associated with the first device, tracking data associated with the first user; causing, based at least in part on the image data, a virtual representation of the first user to be presented on a display of a second device corresponding to a second user; determining an interaction between an object associated with the second user and the virtual representation of the first user; and based at least in part on the interaction, causing virtual content to be presented on the virtual representation of the first user on at least the display, wherein the virtual content is positioned on the virtual representation of the first user based on the tracking data and to visually indicate a position on the virtual representation of the first user where the object interacts with the first user.

BF. One or more computer storage media as paragraph BE recites, wherein causing the virtual content to be presented on the virtual representation of the first user comprises causing, based at least in part on the tracking data, the virtual content to persist in the position on the virtual representation of the first user such to track with movement of the first user.

BG. One or more computer storage media as either BE or BF recites, wherein the virtual content corresponding to the interaction is defined by the second user.

Although the subject matter has been described in language specific to structural features and/or methodological acts, it is to be understood that the subject matter defined in the appended claims is not necessarily limited to the specific features or acts described. Rather, the specific features and acts are described as illustrative forms of implementing the claims.

Conditional language such as, among others, “can,” “could,” “might” or “can,” unless specifically stated otherwise, are understood within the context to present that certain examples include, while other examples do not necessarily include, certain features, elements and/or steps. Thus, such conditional language is not generally intended to imply that certain features, elements and/or steps are in any way required for one or more examples or that one or more examples necessarily include logic for deciding, with or without input or prompting, whether certain features, elements and/or steps are included or are to be performed in any particular example. Conjunctive language such as the phrase “at least one of X, Y or Z,” unless specifically stated otherwise, is to be understood to present that an item, term, etc. can be either X, Y, or Z, or a combination thereof.

What is claimed is:

1. A system comprising:
one or more processors;
memory; and
one or more modules stored in the memory and executable by the one or more processors to perform operations comprising:
determining initiation of a communication between a first device associated with a first user and a second device associated with a second user, the second device being remotely located from the first device;
receiving, from an image capturing device associated with the first device, image data associated with the first user;
receiving, from a tracking device associated with the first device, tracking data associated with the first user;
causing, based at least in part on the image data, a virtual representation of the first user to be presented on a first display corresponding to the second device;
determining an interaction between an object associated with the second user and the virtual representation of the first user;
causing virtual content to be presented on at least the first display corresponding to the second device in a position on the virtual representation of the first user corresponding to the interaction; and
causing, based at least in part on the tracking data, the virtual content to track with movement of the first user.

2. The system as claim 1 recites, wherein:
the first display comprises a touchscreen display; and
the interaction is between the object and a portion of the touchscreen display corresponding to the virtual representation.

3. The system as claim 2 recites, wherein the object comprises a body part of the second user.

4. The system as claim 1 recites, wherein the object comprises an input peripheral device controlled by the second user.

5. The system as claim 1 recites, the operations further comprising, based at least in part on the interaction, causing the virtual content to be presented on a second display associated with the first device in the position on the virtual representation of the first user.

6. The system as claim 1 recites, the operations further comprising determining a first unique identifier associated with the first user and second unique identifier associated with the second user.

7. The system as claim 6 recites, the operations further comprising mapping the virtual content to at least one of the first unique identifier or the second unique identifier.

8. The system as claim 6 recites, wherein permissions data associated with at least one of the first unique identifier or the second unique identifier indicates authorizations associated with at least one of the first user or the second user for terminating the virtual content from being presented on at least the first display.

9. The system as claim 1 recites, the operations further comprising terminating the virtual content from being presented on at least the first display based at least in part on expiration data associated with the virtual content.

10. A method for causing virtual content to be presented in a remote communication environment, the method comprising:
receiving, from an image capturing device associated with a first device, image data associated with a first user corresponding to the first device;
causing, based at least in part on the image data, a virtual representation of the first user to be presented on a second device corresponding to a second user;
determining an interaction between an object associated with the second user and the virtual representation of the first user; and
based at least in part on the interaction, causing virtual content to be presented on the virtual representation of the first user on a first display of the first device and a second display of the second device.

11. The method as claim 10 recites, wherein causing the virtual content to be presented on the virtual representation of the first user comprises causing the virtual content to be rendered in a position on the virtual representation of the first user corresponding to the interaction.

12. The method as claim 11 recites, further comprising:
receiving, from a tracking device associated with the first device, tracking data associated with the first user; and
causing, based at least in part on the tracking data, the virtual content to persist in the position on the virtual representation of the first user such to track with movement of the first user.

13. The method as claim 12 recites, wherein the image data and the tracking data are received over a period of time.

14. The method as claim 10 recites, further comprising prior to causing the virtual content to be presented on the virtual representation of the first user on the first display and the second display, accessing first permissions data associated with the first user and second permissions data associated with the second user.

15. The method as claim 14 recites, further comprising, based at least in part on accessing the first permissions data and the second permissions data, determining that the interaction is authorized between the first user and the second user.

16. The method as claim 14 recites, further comprising:
determining that the remote communication environment includes the first user, the second user, and a third user;
accessing third permissions data associated with the third user; and
determining, based at least in part on at least one of the first permissions data, the second permissions data, or the third permissions data, that the third user is not authorized to view the virtual content.

17. The method as claim 14 recites, further comprising:
terminating a first communication associated with causing the virtual content to be presented on the virtual representation of the first user on the first display and the second display;
determining initiation of a new communication between the first user device and the second user device;
determining that the virtual content is mapped to the first unique identifier and the second unique identifier;
determining that the virtual content has yet to expire; and
causing the virtual content to be presented on the virtual representation of the first user on the first display and the second display for at least a portion of the new communication.

18. One or more computer storage media having computer-executable instructions that, when executed by one or more processors, configure the one or more processors to perform operations comprising:
receiving, from an image capturing device associated with a first device, image data associated with a first user corresponding to the first device;
receiving, from a tracking device associated with the first device, tracking data associated with the first user;
causing, based at least in part on the image data, a virtual representation of the first user to be presented on a display of a second device corresponding to a second user;
determining an interaction between an object associated with the second user and the virtual representation of the first user; and
based at least in part on the interaction, causing virtual content to be presented on the virtual representation of the first user on at least the display, wherein the virtual content is positioned on the virtual representation of the first user based on the tracking data and to visually indicate a position on the virtual representation of the first user where the object interacts with the first user.

19. One or more computer storage media as claim 18 recites, wherein causing the virtual content to be presented on the virtual representation of the first user comprises causing, based at least in part on the tracking data, the virtual content to persist in the position on the virtual representation of the first user such to track with movement of the first user.

20. One or more computer storage media as claim 18 recites, wherein the virtual content corresponding to the interaction is defined by the second user.
